(19) United States
(12) Patent Application Publication
(10) Pub. No.: US 2011/0268882 A1
(43) Pub. Date: Nov. 3, 2011

(54) Ball spacer method for planar object leveling

(75) Inventors: John Edward Bussan, Naperville, IL (US); Jason R. Haaheim, Chicago, IL (US); John Moskal, Chicago, IL (US); Edward R. Solheim, Mount Prospect, IL (US); Vadim Val-Khvalabov, Chicago, IL (US); Michael R. Nelson, Libertyville, IL (US); Nabil A. Amro, Wheeling, IL (US); Javad M. Vakil, Morton Grove, IL (US)

(73) Assignee: Nanolnk, Inc.

(21) Appl. No.: 13/064,925

(22) Filed: Apr. 26, 2011

Related U.S. Application Data
(60) Provisional application No. 61/328,557, filed on Apr. 27, 2010.

(51) Int. Cl. B05D 5/00; B05C 13/00

(52) U.S. Cl. 427/256; 118/663; 118/500

(57) ABSTRACT

An apparatus for leveling an array of microscopic pens with respect to a substrate surface is provided. The apparatus includes an array of microscopic pens; a substrate having a substrate surface; a controllable arm comprising a spherical ball on an end thereof; a force sensor configured to measure a force exerted on the array or the substrate surface at each of the plurality of positions; one or more actuators configured to drive the array and/or the substrate to vary a relative distance and a relative tilting between the array and the substrate surface; and a controller configured to determine a planar offset of the array with respect to the substrate and initiate a leveling of the array with respect to the substrate based on the planar offset. Methods are also provided.

### CROSS-REFERENCE TO RELATED APPLICATIONS

This application claims priority from U.S. Provisional Application No. 61,328,557, filed Apr. 27, 2010, which is hereby incorporated by reference in its entirety.

### BACKGROUND

Microscale tips and nanoscale tips can be used for high resolution patterning, imaging, and data storage. In patterning or printing, an ink or patterning compound can be transferred from the tip to a surface such as a substrate surface. For example, the tip can be an atomic force microscope (AFM) tip attached to one end of a cantilever or a larger support structure. Using arrays of such cantilever tips, dip-pen nanolithography (DPN) can be a promising technology for patterning nanomaterials. In another embodiment of DPN patterning, Polymer-pen lithography (PPL) provides another embodiment for array based patterning which can involve a cantilever-free lithographic approach that uses elastomeric tips.

These direct-write nanolithographic approaches can provide advantages which competing nanolithographies may not provide, such as high registration, throughput, multiplexing, versatility, and lower costs. Various approaches are described in, for example, Mirkin et al, WO 00/41213; WO01/91855; U.S. Patent Application Pub. No. 2009/0325816; Small, 2005, 10, 940-945; Small, 200901538; See also U.S. Pat. Nos. 7,005,378; 7,034,854; 7,060,977; 7,098,056; and 7,102,656; and U.S. Patent Application Pub. No. 2009/0205091 to NanoInk.

In many applications 1D or 2D arrays of such tips are used. As the tip arrays become more geometrically complex and larger with more tips, leveling of the array becomes more difficult. If the array is not level with the substrate surface, one tip may touch the surface before another tip touches the surface, or the other tip may not even touch the surface at all. It may also be difficult to know when the tips touch the surface. In many cases, it is desired that most or all of the tips are in contact with the surface when writing, and most or all are off the surface when not writing.

Once the two dimensional spatial profile of the array is established, it is desirable to have a high degree of planarity for the 2D array of tips or cantilever tips; otherwise, during lithography cantilevers and tips can be damaged or writing may not become satisfactory.

An example of prior methods for leveling is provided in Liao et al., “Force-Feedback Leveling of Massively Parallel Arrays in Polymer Pen Lithography”, Nano Lett., 2010, 10(4), 1335-1340.

### SUMMARY

Embodiments described herein include, for example, devices, instruments, and systems, methods of making devices, instruments, and systems, and methods of using devices, instruments, and systems. Computer readable media, hardware, and software are also provided. Kits are also provided. Kits can comprise instruction materials for using instruments, devices, and systems.

One embodiment is directed to an apparatus comprising: an array of microscopic pens; a substrate having a substrate surface; a controllable arm comprising a ball on an end thereof, wherein the controllable arm is configured to move the ball to a plurality of positions between the array and the substrate surface; a force sensor configured to measure a force exerted on the array or the substrate surface at each of the plurality of positions; one or more actuators configured to drive the array and/or the substrate to vary a relative distance and a relative tilting between the array and the substrate surface; and a controller configured to (i) determine a planar offset of the array with respect to the substrate based on a distance traveled by the array or the substrate at each of the plurality of positions before the force measured by the force sensor exceeds a given threshold, and (ii) initiate a leveling of the array with respect to the substrate using the one or more actuators based on the planar offset.

One embodiment is directed to a method comprising: moving a ball to a plurality of positions between an array of microscopic pens and a surface of a substrate; at each of the plurality of positions, (i) decreasing a relative distance between the array and the substrate surface using one or more actuators until the ball contacts both the array and the substrate surface and a force measured by a force sensor exceeds a given threshold, and (ii) determining a distance traveled by the array or the substrate before the force measured by the force sensor exceeds the threshold; and determining a planar offset of the array with respect to the substrate surface based on the determined distances.

One embodiment is directed to a method comprising: moving a ball to a plurality of positions between an array of microscopic pens and a surface of a substrate; determining a planar offset of the array with respect to the substrate surface using the ball.

One embodiment is directed to an apparatus comprising: an array of microscopic pens; a substrate; a robotic arm configured to place a single ball between the array and the substrate at a plurality of corners of the array; a force sensor configured to measure a force applied to the array or the substrate; and a controller configured to level the array to the substrate based at least in part on the measured forces.

One embodiment is directed to a method comprising: using a robotic arm to place a single ball between an array of microscopic pens and a substrate at a plurality of corners of the array; measuring a force applied to the array or the substrate at each of the plurality of corners of the array; and leveling the array to the substrate based at least in part on the measured forces.

One embodiment is directed to an apparatus comprising: a mounting frame configured to be attached to a load cell chassis, the mounting frame comprising a controllable arm, and the controllable arm comprising a spherical ball on an end thereof. The controllable arm is configured to move the ball to a plurality of positions between an array and a substrate surface.

One embodiment is directed to an apparatus comprising: an array of microscopic pens; a substrate having a substrate surface; a force sensor configured to measure a force exerted on the array or the substrate surface; one or more actuators configured to drive the array and/or the substrate to vary a relative distance and a relative tilting between the array and the substrate surface; a plurality of balls, each ball being located at one of a plurality of positions on the array or the substrate surface; and a controller configured to (i) determine a planar offset of the array with respect to the substrate based on a distance traveled by the array or the substrate at each of the plurality of positions before the force measured by the force sensor exceeds a given threshold and (ii) initiate a leveling of the array with respect to the substrate using the one or more actuators based on the planar offset.

One embodiment is directed to a method comprising: providing an array of microscopic pens and a substrate having a substrate surface, wherein either the array or the substrate comprises a plurality of balls, each ball being located at one of a plurality of positions on the array or the substrate surface; at each of the plurality of positions, (i) lining up the ball at that position with an opposing portion of the array or substrate surface, (ii) decreasing a relative distance between the array and the substrate surface using one or more actuators until the ball contacts the opposing array or substrate surface and a force measured by a force sensor exceeds a given threshold, and (iii) determining a distance traveled by the array or the substrate before the force measured by the force sensor exceeds the threshold; and determining a planar offset of the array with respect to the substrate surface based on the determined distances.

At least one advantage for at least one embodiment comprises better leveling, patterning, and/or imaging. Leveling, patterning, and/or imaging can be faster and more reproducible, for example.

### BRIEF DESCRIPTION OF FIGURES

FIG. 1A is a side view of a system for leveling or for measuring a surface planarity.

FIG. 1B is a perspective view a system for leveling or for measuring a surface planarity.

FIG. 1C is a schematic diagram showing a perfectly planar 2D nano PrintArray (2D nPA® by NanoInk) at the initial point of contact, and after 6 μm of deflection grounding out on the standoffs. In this embodiment, the freedom of travel (F.O.T.) was 6 μm.

FIGS. 1D and 1E are schematic diagrams of a scenario where the 2D nPA approaches the limit of angular tolerance.

FIG. 1F is a schematic diagram illustrating a planarity with respect to an array chip and a substrate, and the parameters used to define thereof.

FIG. 2A is a flow chart for an automatic leveling process.

FIG. 2B is a flow chart for an process including adaptive leveling.

FIG. 3A illustrates the basic principle of obtaining derivatives.

FIGS. 3B and 3C illustrate various force curves and their derivatives.

FIGS. 4A and 4B show force-distance curves for the 2D nPA interacting with the substrate at its initial planarity (no Tₓ, T_{y} adjustments).

FIGS. 5A and 5B show the force-distance curves for an Elastomeric Polymer Tip (EPT) array (fabricated on a transparent glass backing-substrate).

FIGS. 6A-6C show the collection of force curves for the 2D nPA collected at various Tₓ positions.

FIGS. 7A-7C show the collection of force curves for the EPT array collected at various Tx positions.

FIGS. 8A-8C show force-distance curve measurements of the OHaus scale against a rigid object, verifying that the scale itself behaves in a linear way, and therefore would not compromise any subsequent system measurements.

FIG. 9 shows an embodiment of a ball-spacer apparatus.

FIG. 10 shows a close-up of the embodiment of the ball-spacer apparatus depicted in FIG. 9.

FIG. 11 shows a top perspective view of an embodiment of a load-cell chassis that may be used in a ball-spacer apparatus.

FIG. 12 shows a top perspective view of a load-cell digitizer that may be included in the embodiment of the load-cell chassis depicted in FIG. 11.

FIG. 13 shows an exploded bottom perspective view of a load-cell digitizer located in the embodiment of the load-cell chassis depicted in FIG. 11.

FIG. 14 shows a top perspective view of a mounting block of the embodiment of the load-cell chassis depicted in FIG. 11.

FIG. 15 shows an exploded top perspective view of the embodiment of the load-cell chassis depicted in FIG. 11.

FIG. 16 shows a top perspective view of an embodiment of a mounting frame that holds a controllable arm.

FIG. 17 shows an exploded top perspective view of the embodiment of the mounting frame depicted in FIG. 16.

FIG. 18 shows an exploded bottom perspective view of the embodiment of the mounting frame depicted in FIG. 16.

FIG. 19 shows a top perspective view of an embodiment in which a mounting frame is attached to a load-cell chassis.

FIG. 20 shows a bottom perspective view of an embodiment in which a mounting frame is attached to a load-cell chassis.

FIG. 21 shows a top perspective view of an embodiment of a load-cell chassis and a mounting frame that may be connected to the load-cell chassis along an edge thereof.

FIG. 22 shows a bottom perspective view of an embodiment of a load-cell chassis and a mounting frame that may be connected to the load-cell chassis along an edge thereof.

FIG. 23 shows a front view of an embodiment of a load-cell chassis.

FIG. 24 shows a side view of an embodiment of a load-cell chassis.

FIG. 25 shows a sample graph of the force measured by the load cell vs. the position of the stage plate when the contact occurs.

FIG. 26 shows a graph with curves indicating the positions of the stage plate vs. time for each of the three positions between the array and the substrate, along with a curve showing the planar offset of the array with respect to the substrate vs. time.

FIG. 27 shows two tips in contact with a substrate, where there is a planar offset of the tips with respect to the substrate.

FIG. 28 is a graph showing the contact measurement precision required to obtain an intended dot size.

FIG. 29 is a flow chart for an embodiment of the ball-spacer method.

FIG. 30 depicts a 5 mm by 5 mm area that has been printed with an array that is not perfectly parallel to a substrate surface.

FIG. 31 depicts a 5 mm by 5 mm area that has been printed after the substrate was leveled to the array using the above-described method.

### DETAILED DESCRIPTION

### Introduction

Non-provisional Patent Application entitled Force Curve Analysis Method for Planar Object Leveling, filed herewith, (attorney docket no. 083847-0737; Ser. No. ______) is hereby incorporated by reference in its entirety.

All references cited in this application are hereby incorporated by reference in their entirety. The following references may aid the understanding and/or practicing the embodiments disclosed herein:

Haaheim et al., Self-Leveling Two Dimensional Probe Arrays for Dip Pen Nanolithography®, Scanning, 2010 (in press);

Salaita K. S., Wang Y. H., Fragala J., Vega R. A., Liu C., Mirkin C. A.: Massively parallel dip-pen nanolithography with 55000-pen two-dimensional arrays, Angewandte Chemie-International Edition 45, 7220-7223 (2006);

Huo et al., Polymer Pen Lithography, Science 321 1658-1660 (2008);

NanoInk U.S. Patent Application Pub. Nos. 2008/0055598: “Using Optical Deflection of Cantilevers for Alignment,” 2008/0309688: “Nanolithography with use of Viewports;” 2009/0023607: “Compact nanofabrication apparatus;” 2009/0205091: “Array and cantilever array leveling;” Provisional Application Nos. 61/026,196, “Cantilever Array Leveling,” and 61/226,579, “Leveling Devices and Methods;”

U.S. Patent Application Pub. Nos. 2005/0084613: “Sub-micron-scale patterning method and system;” 2005/0160934: “Materials and methods for imprint lithography;” 2010/0089869: “Nanomanufacturing devices and methods;” 2009/0325816: “Massively parallel lithography with two-dimensional pen arrays;” 2009/0133169: “Independently-addressable, self-correcting inking for cantilever arrays,” 2008/0182069: “Etching and hole arrays;” 2008/0105042: “Massively parallel lithography with two-dimensional pen arrays;” 2007/0087172: “Phase separation in patterned structures,” 2003/0007242: “Enhanced scanning probe microscope and nanolithographic methods using the same.”

### Leveling

Leveling generally involves making a first generally flat surface to be substantially parallel to a second generally flat surface. In the applications of nanoscopic or microscopic patterning, printing, or imaging, the first surface is usually a plane defined by an array of tips, and the second surface can be a substrate surface on which the pattern is formed.

For DPN-related technologies, including PPL technologies, leveling is particularly important to successful nanoscale patterning once the printing system is beyond a single tip/cantilever system. In order to ensure uniform patterning, 1D arrays of tips must be substantially level with the surface over which the pattern to be printed.

Embodiments disclosed herein relate to methods for planar object leveling, wherein two planar objects can be leveled to each other, particularly when either or both comprise a compressible or flexible material or object with compressible/flexible elements. In some embodiments, the tips of the DPN printing can be substantially rigid, while the tips are disposed on a flexible/compressible backing. Embodiments disclosed herein can apply not only to DPN printing from tips (made of SiN, PDMS, etc.), but also apply to any compressible/flexible objects or objects with compressible/flexible components, such as flexible/springy cantilevers, rubbery PDMS tips, a box spring mattress, a pCP stamp, or even a kitchen sponge.

In some embodiments, leveling is carried out with at least 16, or at least 100, or at least 1,000, or at least 10,000, or at least 100,000, or at least 1,000,000 tips on a single array.

In some embodiments, leveling is such that at least 80% of the tips are in contact with the substrate surface, or at least 90%, or at least 95%, or at least 98%, or at least 99% of the tips are in contact with the surface. Contact can be determined by what percentage of the tips generating patterning may transfer of material from the tip to the substrate.

Examples of square area for arrays to be leveled include, for example, at least 1 square μm, at least 500 square μm, or at least one square cm, or at least ten square cm, or at least 50 square cm, for example, can be many square meters.

### Derivative Introduction

In accordance with an embodiment, an approach for leveling between two surfaces of two objects or measuring the planarity or tilting angles of a surface employs varying a relative distance between the surfaces and obtaining a derivative of force to the distance. Distance can be also expressed as a function of time. Alternatively, the derivative can be obtained for a first distance and a second distance, wherein the first and second distances include, for example, an actuation distance or a response distance, as described in detail below. The derivative between the first and second distances is related to the force derivative, and thus can be used for leveling as well.

The distance can be varied, for example, at a constant rate, using an actuator that drives one or both of the objects. The force between the probes and the surface can be measured as a function of the distance. When the probes and the substrate surface are not perfectly level, one of the probes may come into contact with the surface first, with progressively more probes contacting the surface as the distance becomes smaller, resulting in an increase in the feedback force that can be measured.

A derivative of the force over the distance can be calculated. If the probes and the surface are relatively level with each other, as the distance between them changes, a change in force, i.e., a derivative of the force, will be faster compared with the case that there is a larger tilting between the probes and the surface.

Mathematically, this manifests as measuring the derivative of force to the distance and finding its maximum value φ₀:

$${φ}_{0} ∝ \frac{d F}{d {z}_{ma x}} ,$$

which indicates a desired level position. By changing a tilting between the probes and the surface, and repeatedly measuring the above force derivative, the force derivatives can be plotted as a function of the tilting in both x (Tₓ) and y (T_{y}) directions. By finding the maximum value of the derivatives, the best leveling can be achieved.

The leveling system in accordance with embodiments disclosed herein can have an actuator to drive a backing of the probes, or to drive the substrate, to have a constant change in their relative distance, i.e., dZ/dt=constant. Subsequently, one has

$${φ}_{0} ∝ \frac{d F}{d {t}_{ma x}} .$$

In accordance with some embodiments, the derivative can be an n-th order derivative, wherein n is an integer:

$${φ}_{0} ∝ \frac{{d}^{n} F}{d {z}^{n}}$$

In systems where the force (F) exerted by the compressible/flexible material varies non-linearly, the higher-order derivatives better characterize the leveling. In particular, taking a series of n derivatives greater-than-or-equal to the power of the force (m) dependence will eventually yield a single constant (C_{final}) for n≧m such that:

$$F ( z ) = - {C}_{0} k \cdot {z}^{m} … ⇒ {φ}_{0} ∝ \frac{{d}^{n} F ( z )}{d {z}^{n }} = - {C}_{1} \cdot \frac{{d}^{n} {z}^{m}}{d {z}^{n} } = - {C}_{2} \cdot {mz}^{m - 1} + - {C}_{3} \cdot ( m - 1 ) {z}^{m - 2} + … = {C}_{final}$$

For example, if F is proportional to z³, differentiating the curve once yields a parabola. The second-order derivative yields an upward sloping line. The third-order derivative yields a constant value.

Regardless of the complexity of the original curve, it can always be turned into a collection of constants through a sufficient number of differentiations. This collection of constants (C_{final}) can indicate the force-maximum, and the force-maximum can be highest for the largest values of the constants. In other words, the system will have achieved a maximum planarity when C_{final}=Cₘₐₓ.

Along the way, the various force curves (linear or nonlinear) provide a richly detailed spectrum that describes a material's (or collection of components') compression characteristics. Applying successive differentiation to these force curves yields quantitative information which can be meaningfully compared, and can be used when dealing with the same material/object in order to have “smart-iterative” push-button leveling automation. The automation becomes possible because the force derivative methods (FDM) allow leveling or measuring the tilting from any linear or non-linear compressible material or collection of components.

### Distance Variation and Measurement

Various measurements or definitions about the distance variation can be made for a leveling system. For example, two different z-displacement values can be defined: z_{actuation} and zᵣₑₛₚₒₙₛₑ. The z_{actuation} can be the z-travel measured by an actuating stage (e.g., which can be accurate to +/−5 nm). This is different from the resultant motion of any arrays, materials, compressible objects, or other objects comprising them. The zᵣₑₛₚₒₙₛₑ indicates the amount that the compressible or flexible object compresses or deflects in response to the actuation; this may be subsequently measured by one or more sensors such as capacitive or interferometric sensors.

The force-distance relationships can thus be reformulated as:

$$F ( z ) = - k \cdot z -> F ( {z}_{response} ) = - k \cdot {z}_{response} ; \frac{d F ( z )}{d z} -> \frac{d F ( {z}_{response} )}{d {z}_{actuation}} .$$

By a substitution:

$${ϕ}_{0} ∝ \frac{d F ( {z}_{response} )}{d {z}_{actuation}} ; {ϕ}_{0} ∝ \frac{d {z}_{response}}{d {z}_{actuation }} ;$$

send for constant

$$\frac{d {z}_{actuation}}{d t} , {ϕ}_{0} ∝ \frac{d F ( {z}_{response} )}{d t} ; {ϕ}_{0} ∝ \frac{d {z}_{response}}{d t} ,$$

several additional relationships can be obtained, and the distance variations can be monitored as variations of the “force-derivative method.” For example, dzᵣₑₛₚₒₙₛₑ/dz_{actuation} indicates the change in one z-value with respect to another, and instead of force/load measurements and force derivatives, the distance variations can be measured, and the derivative of one distance over another can be used for leveling or planarity measurements. This is due to the fact that dzᵣₑₛₚₒₙₛₑ/dz_{actuation} is closely related to the force derivative as discussed above.

The distance between the two surfaces can be measured optically, or using a capacitive sensor, or can be directly obtained from the controller for the actuator. Like the measurements of the force, the true or absolute distance needs not to be accurately calibrated. For example, if the measured distance is the true distance multiplied by or added with a constant, the derivative of the measured force to the measured distance can still be used to find the maximum value for leveling.

Actuators, motors, and positioning systems are known in the art, including, for example, nanoscale positioners and piezoelectric actuators.

The device for measuring the distance can be integrated with the force sensor(s) to measure the force feedback and distance simultaneously.

### Leveling System

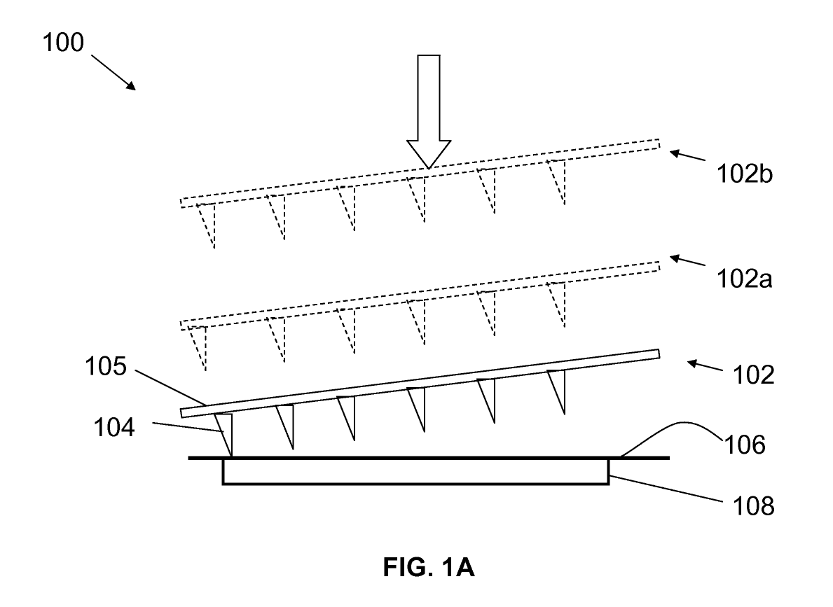

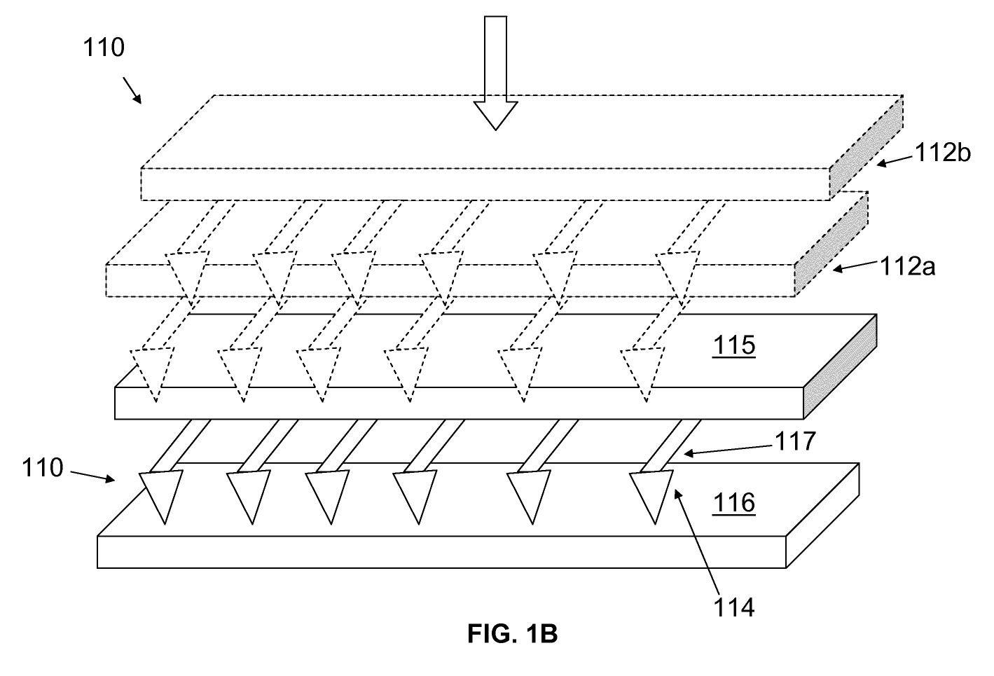

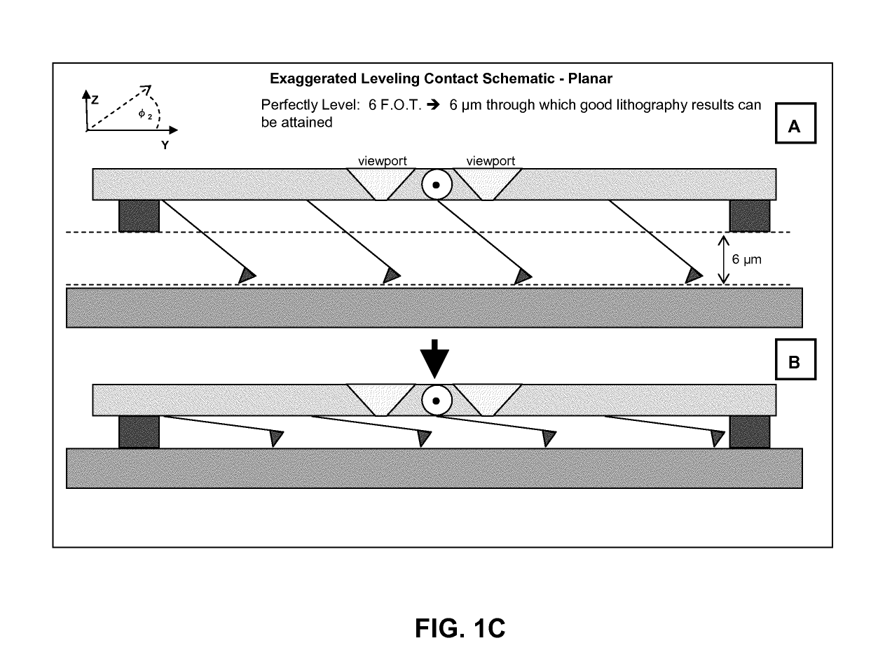

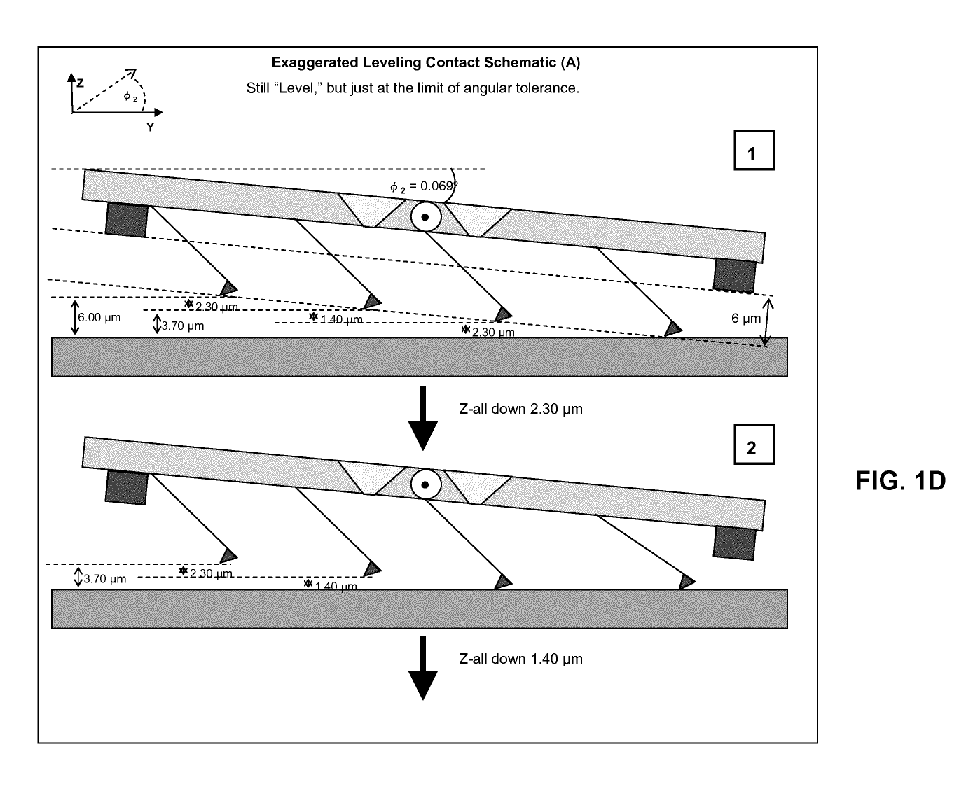

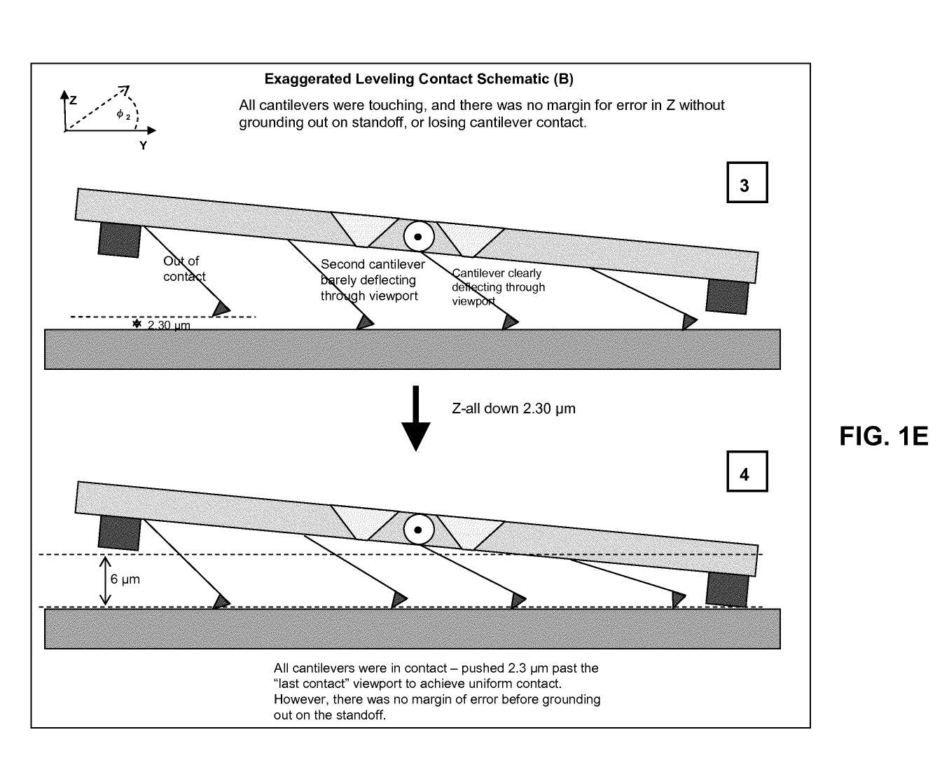

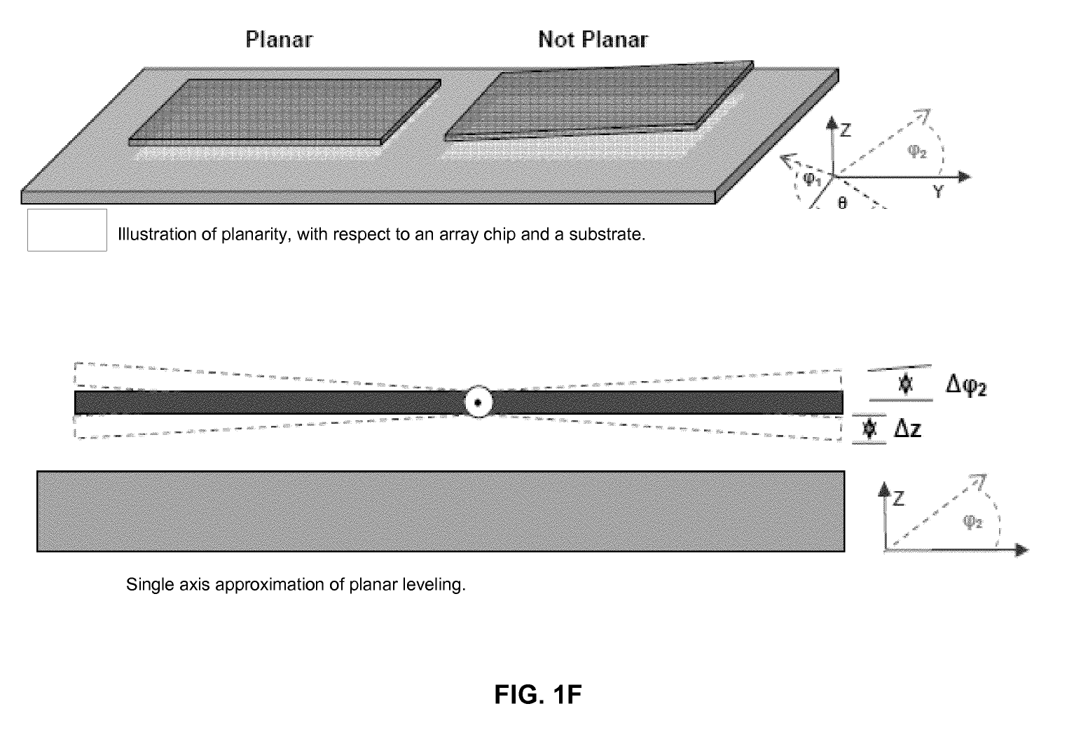

An exemplary system 100 for leveling or for measuring the planarity is illustrated in FIG. 1. In this exemplary embodiment, the array 102 of tips or probes 104 can have a backing 105. The tips can be cantilever-free EPTs, or can be DPN tips disposed over their respective cantilevers. The backing 105 together with the tips can be driven in the z direction by an actuator (not shown), and the feedback force can be measured along the way in a plurality of positions such as 102a, 102b. Note that although in the exaggerated view shown in FIG. 1A at positions 102a, 102b none of the tips 104 touches the substrate surface 106, the force and the relative position between the array 102 and the substrate surface 106 can be measured at a plurality of positions at which at least one of the tips 104 contacts the surface 106 thereby generating a sufficiently large feedback force for measurement by one or more force sensors (not shown). To obtain the derivative, measurements can be made at, for example, at least three positions.

The substrate can be disposed over an actuator such as the Z-stage 108, which can drive the substrate to vary its distance to the plane defined by the tips 104.

FIG. 1B is a perspective view of a system 110 for leveling or for measuring the planarity. In this exemplary embodiment, the array 112 of tips or probes 114 are coupled to a backing 115 through cantilevers 117. Although a 1D array is shown, 2D arrays can be deployed.

The backing 115 together with the tips 114 and cantilevers 117 can be driven in the z direction by an actuator (not shown), and the feedback force can be measured along the way in a plurality of positions such as 112a, 112b. Typically measurements are made in at least three positions to obtain the derivative.

Note again that although in the exaggerated view shown in FIG. 1B at positions 112a, 112b none of the tips 114 touches the substrate surface 116, the force and the relative position between the array 112 and the substrate surface 116 are actually measured at a plurality of positions at which at least one of the tips 114 contacts the surface 116 thereby generating a sufficiently large feedback force for measurement by one or more force sensors (not shown).

At least one of the tips 114, the cantilevers 117, the backing 115, or the substrate surface 116 is compressible or flexible. Preferably only one of these elements, such as the tips 114 or the cantilevers 117, are compressible or flexible, while the other elements in the mechanical loop are substantially rigid, such that the measured force is not a convolution of a plurality of compression/deflection variables.

In the system 100 or 110, the applied force F and its change versus displacement z or time t, are readily measurable, and the relationship between the tilting of the array and the substrate surface is derived from fundamental behaviors of the tips interacting with the surface from first principles in physics, calculus, and basic mechanics. This approach allows the system to be implemented as a rapid automation system.

The methods disclosed herein are not limited to the system 100 that employs EPT. Rather, the methods can be used for DPN, uCP, NIL, standard rubber stamping, different print-transfer methods, flexible electronics printing methods, etc.

The concept of Freedom of Travel (F.O.T.) can be particularly important in the systems. FIG. 1C illustrates this concept for one embodiment in which a planar 2D nano PrintArray with 6 μm F.O.T., where (A) illustrates a “feather touch” situation (where the tips are just beginning to touch the substrate), and (B) illustrates the “hard crunch” (where the cantilevers have gone through their full 6 μm freedom of travel, and the array is now grounding out on the standoffs). Thus, in this embodiment, initial z-positioning of anywhere from 0.1 to 5.9 μm within the F.O.T. can yield excellent lithography with uniform contact, while the extreme of 0.0 μm can lead to no writing (i.e., no contact), and 6.0 μm can lead to distorted writing (standoffs grounding out). In other words, in this embodiment, after making first contact (i.e., uniform contact) with the substrate, there was a 6.0 μm margin of error before grounding out on the standoffs.

FIGS. 1D and 1E illustrate a situation where the 2D nPA was not perfectly planar, but still within the tolerance to achieve uniform writing. (1) and (2) show that by the time first contact was observed in the “lowest” viewport, the cantilevers at the edge of the device have already deflected 2.30 μm. Cantilever deflection can be monitored for example by observing how and when the cantilevers naturally change color. According to (3), after another 1.40 μm, the “highest” viewport was deflecting, but there was still another 2.30 μm to deflect until all the cantilevers tips were uniformly touching (4), thereafter there would be no margin of error, and the standoff was nearly touching the substrate.

Because the 2D nPA device is often imperfectly parallel (level) to the substrate, a pertinent question during processing becomes how to achieve and verify uniform contacts of all of the tips, or many or a majority of the tips, without driving the corners of the array into the sample, which would lead to sample scratching, pattern distortion, and/or arraying fishtailing during lithography. The “levelness” (or “planarity”) of the 2D nPA with respect to the substrate can be described in terms of the relative z positions of three distinct points on the 2D nPA as measured by z-axis motors, or as two relative angular difference measurements as measured by goiniometer motors (i.e., φ, θ). A schematic illustration of these parameters is provided in FIG. 1F.

### Automation

A need exists for better automated processes, including both semi- and fully-automated processes.

An automatic leveling system is provided with improved speed for leveling or for planarity/tilting measurements. The automation method does not rely on the need to visualize cantilever deflection for precise leveling, thereby reducing or eliminating the need for human interaction in the process. The automatic system can be operated with a push of a button, and the leveling can be obtained at a predetermined precision or accuracy. Simultaneous quantitative knowledge of the planarity and the applied force or force feedback can be obtained.

In comparison, a conventional method employing manual epoxy attachment technique with a pyrex handle wafer device for leveling may not have the capability of adjusting or fine-tuning the leveling, and may be limited for different substrates. Instrument changes and natural mechanical changes due to stick/slip, thermal expansion/contraction, etc. cannot be taken into account in real time. The pyrex may be heavily etched, and thus roughened, and therefore barely translucent, making it difficult to see the surface or the tips and cantilevers. Thus, it is difficult to judge whether the tips have come into contact with the surface. This limits flexibility of the system in terms of using different samples of different thicknesses, or large samples that are not completely flat. The conventional method also may not be able to align the tips to surface features, such ink wells for multiplexed ink delivery. If may also be difficult to align a laser to the cantilevers for imaging or for measuring the force feedback.

In some methods, evaporated gold can be deposited on the tips in order to observe a light change. However, gold poses limits on the tip chemistry, and also quenches fluorescence while imaging tips. Furthermore, Epoxy takes time (e.g., more than 1 hour) to set, and can bleed ink all over the place, while still introducing volume distortion that affects planarity. This process can also easily contaminate the scanner. If multiplexed ink delivery methods are used to address different inks to different tips, the surface contact time will introduce cross-contamination.

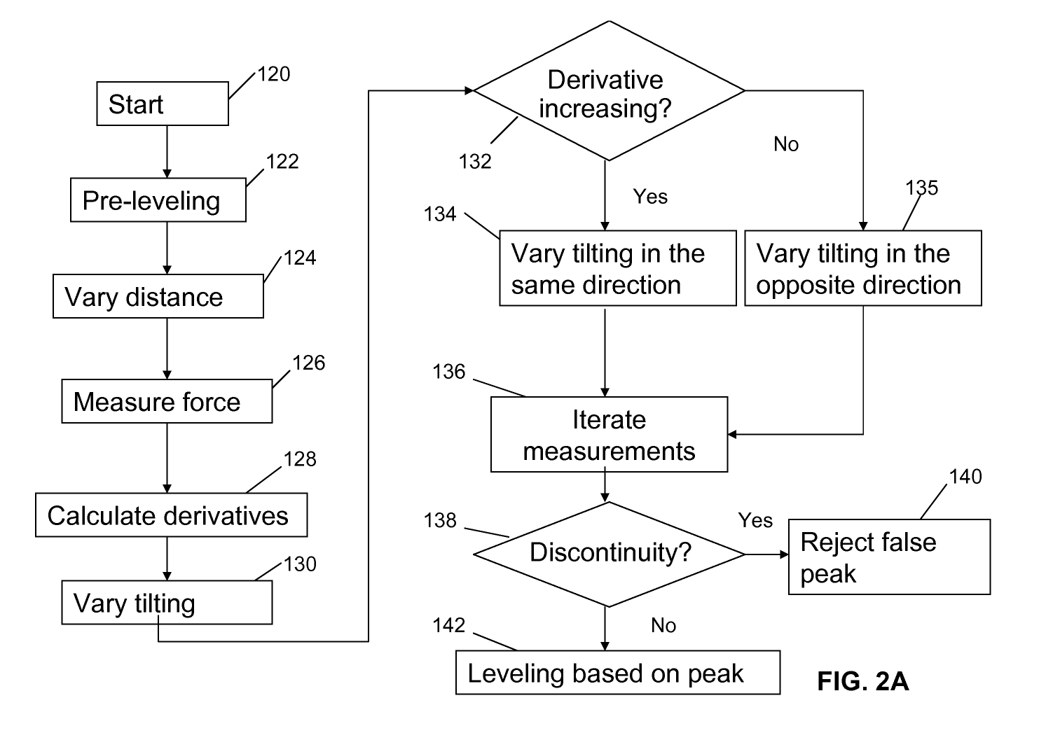

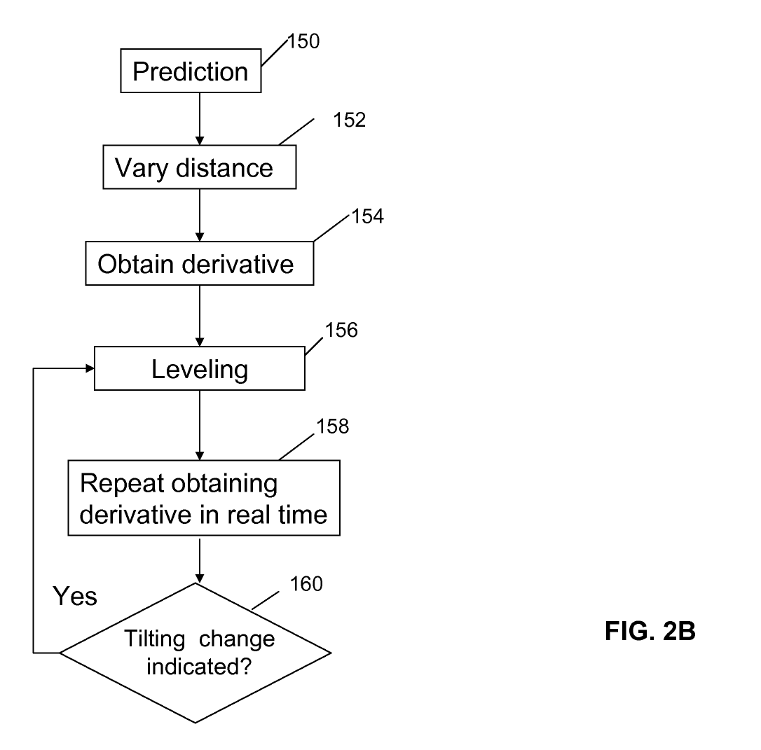

An automatic leveling method is illustrated in the flow chart in FIG. 2A. In step 120, the process is started. The starting procedure can be simply a push of a button, and little or no human intervention is needed afterwards. Or semi-automated processes can be used.

As described in the references cited above, a variety of improvements implemented by NanoInk on both the device (article) and software (methods) have addressed some of the issues in the conventional methods and systems. For example, viewports allow operators to see the cantilevers, and the operators can level the array by inspecting the deflection characteristics of the tips.

Viewports in the silicon handle wafer allows the operators to level the array by inspecting cantilever deflection characteristics at 3 different points. Instead of using epoxy, magnetic force can be employed to hold the components together. For example, a wedge having magnets therein can be used.

Viewport leveling is substantially faster than conventional methods and can be completed, for example, in a matter of minutes, making mounting the device very straightforward via the magnetic wedge, thereby preventing the cross-contamination. Versatility for a variety of different samples includes: different samples of different thicknesses with the same array, moving large distances in x-y directions and correcting for changes in z-displacement, moving across larger samples (that is not necessarily perfectly flat) and maintaining “level,” while the viewports allows the operators to spot check and correct errors. The need for gold can be eliminated by engineering stressed nitride layers on the cantilevers to achieve sufficient freedom of travel for the tips. Because not all chemistries are amenable to gold coated tips, and gold-coated tips quench fluorescence for imaging multiplexed ink on the array, gold-free tips improve the versatility of the system. Further, the fact that the silicon handle chip is not transparent (or even translucent) is desirable because it prevents ambient light from bleaching bio inks. The viewports also provide a way to get a clear laser signal onto a cantilever for imaging and force feedback.

However, human interaction with robust nanomanufacturing solutions based on visual cues still has undesirable aspects. These included, for example, difficult initial “coarse leveling.” This is usually performed subjectively, by eye. If the array is too far out of level initially to enable the middle-of-the-array cantilevers to be touching (because the corners come into contact with the surface first), it becomes very difficult to go through the manual optical-deflection-monitoring algorithm. The system can require significant human interactions in order to achieve leveling. The need for observing optical deflection imposes design constraints on the MEMS, the mechanical hardware, the optics, and the software. More recently-developed passive self-leveling gimbal addresses some, but not all, of the above issues. See, e.g., U.S. Provisional Application Ser. No. 61/226,579, “Leveling Devices and Methods,” filed Jul. 17, 2009, the disclosure of which is hereby incorporated by reference in its entirety. In accordance with some embodiments, a view port is not needed.

These techniques can be incorporated in step 122, a pre-leveling process. Other coarse leveling methods known in the art can also be used. In step 124, a distance between the two objects, e.g., the distance between a first plane defined by the tips of the array of pens and a second plane defined by a substrate surface, can be varied using an actuator. In step 126, a force is measured. The force can be a force applied to one or both of the two objects, or a feedback force measured by a force sensor. In step 128, derivatives of the force to the distance or time are calculated. In step 130, a tilting is varied, e.g., using an actuator. The tilting can be varied in one or both x, y directions. In step 132, a controller such as a computer determines whether the force derivative is increasing. If so, in step 134 the tilting is varied in the same direction to find the peak of the force derivative, and the measurements are iterated in step 136. If the derivative is decreasing, in step 135 the tiling is varied in an opposite direction in an attempt to find the peak value.

In step 138, the controller determines whether the force derivative has discontinuity associated with a peak value. If so, in step 140 the false peak is rejected. In step 142 the two objects are leveled, or a tilting therebetween is measured, based on the peak value in the force derivative.

The derivative method in accordance embodiments disclosed herein allow simultaneous quantitative knowledge of planarity and force. As adapted for automation, it provides real-time, in situ information regarding force-feedback and planarity-feedback. As such, this enables the unprecedented ability to pattern on non-flat surfaces, since the planar-feedback mechanism can adapt in-process to re-level the system. This could include multiple substrates at different planarities, substrates with significant bow or debris, or even spherical surfaces.

An exemplary automatic, adaptive leveling method is illustrated in the flowchart of FIG. 2B. In step 150, a prediction can be made regarding the force-distance, distance-distance, force-time, or distance-time relation shape, as described in detail below. In step 152, a distance is varied based on the prediction. In step 154, a derivative is obtained. In step 156, leveling is obtained between two objects, for example, using iterative methods illustrated in FIG. 2A. The tilting and/or distance between the two objects can change over time. Thus, in step 158, the steps of 152 and 154 are repeated so that the derivative can be obtained in real time. In step 160, it is determined based on the in situ derivative calculation/measurement whether the tilting has changed. If so, the leveling step 156 is repeated to obtain a new, real time leveling.

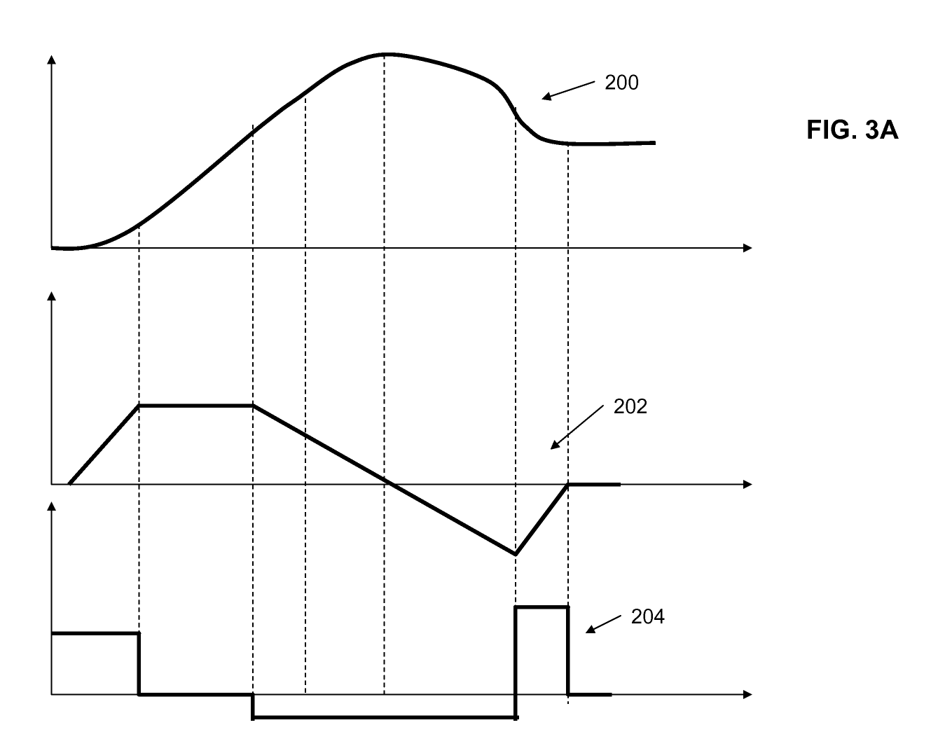

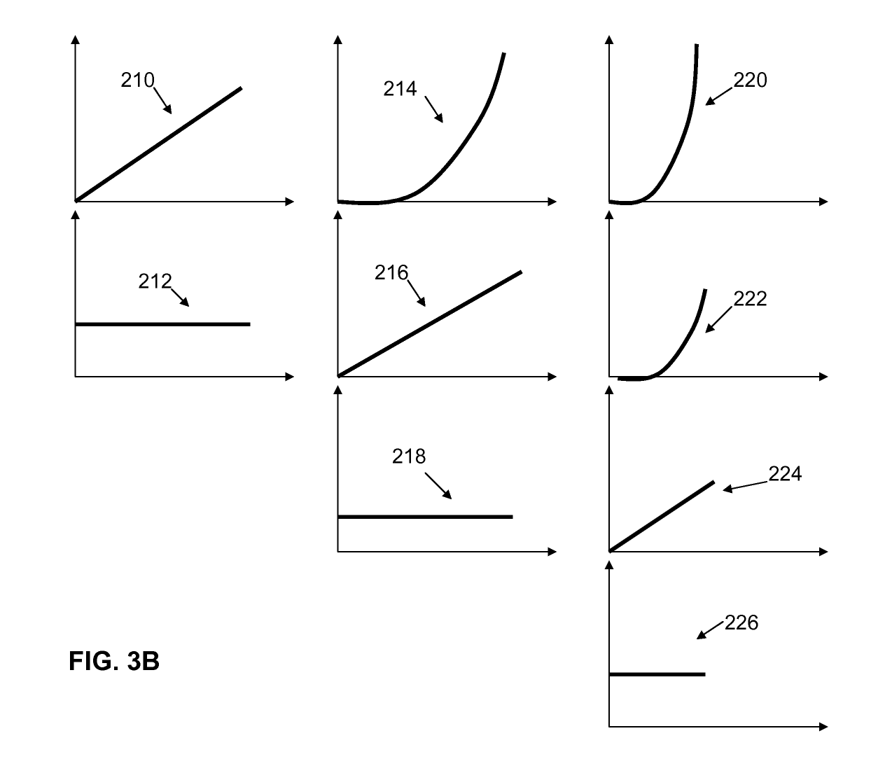

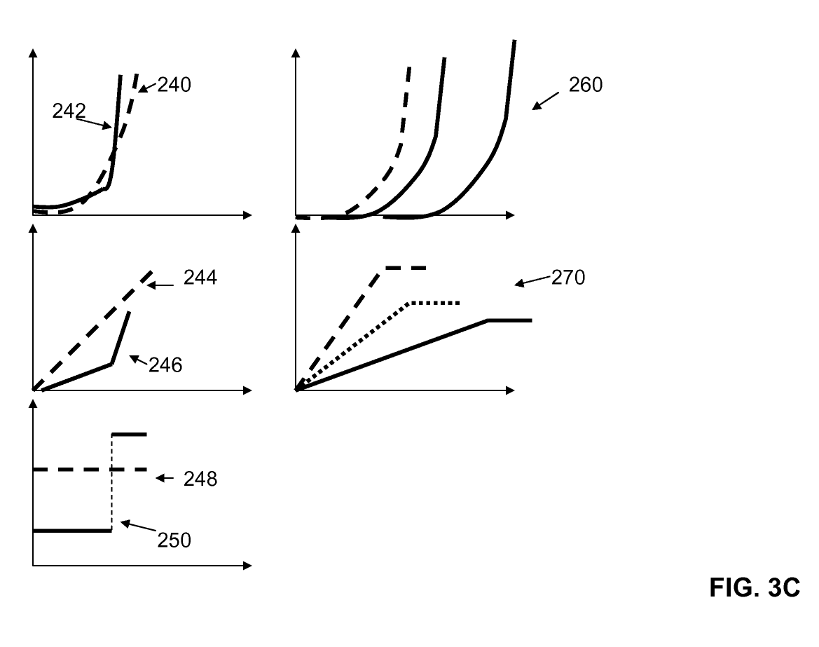

The richness of the information obtained from the derivative method in accordance with the embodiments disclosed herein can be illustrated in FIG. 3A. For example, a curve 200 itself representing a force-distance relationship, a distance-distance relationship, a force-time relationship, or a distance-time relationship show some information about the two objects. However, the information in the first order derivative shown in the curve 202 and the second order derivative shown in the curve 204 cannot be immediately visualized from the curve 200.

The relationships between various force curves and their derivatives are sketched in FIGS. 3B and 3C. For example, as shown in FIG. 3B, the linear relationship 210 (F=kz) has a derivative 212 that is a constant k. The curve 214 (F=Cz²) has a first order derivative 216 that is linear, and a second order derivative 218 that is a constant. The curve 220 (F=Cz³) has a first order derivative 222 in the form of 3Cz², a second order derivative 224 that is linear, and a third order derivative 226 that is a constant.

In FIG. 3C, both curves 240 and 242 are shown to be continuous. The first order derivative 244 of the curve 240, and the first order derivative 246 of the curve 242 show more clearly the difference. The second order derivatives 248, 250 further more clearly show a discontinuity in the curve 250, indicating that, for example, the substrate surface comes into contact with the edge of the chip, which is substantially rigid, rather than contacting the tips.

The three different curves 260 show that the two objects come into contact at different distances. If only a two-point measurement of force is made, the force difference would be the same after all tips touch the substrate surface and the curves behave linearly. However, the derivatives 270 provide more information about the array behaviors and how to level the tips with respect to the substrate surface.

### Force Sensor

A variety of force sensors can be used for the measurements of the feedback force or to obtain the derivative of force. The force sensor can measure the force in the range, for example, of 1 pN to 1 N.

The force sensor(s) can be the Z-piezo and/or capacitive and/or inductive sensors of an existing AFM instrument. The system can be operated in “open-loop” mode and the Z-actuator can both move the device and make force measurements.

In some embodiments, the force sensors can include a multi-stage sensor suitable for force measurements in different ranges or at different levels of accuracy. For example, a first, precision stage can include a precision beam balance and a sensitive spring or flexture. A second stage can include a spring or flexture having a higher force capacity.

### Force Derivative Methods (FDM)

Embodiments disclosed herein help to reduce or entirely remove human interaction for leveling operations, and thereby can make the process semi- or fully automated. An automated machine/robot process can include, placing a substrate on a sample stage using a robotic arm, automatically attaching a printing array to the instrument, using software to detect the presence of both the substrate and the printing array, and to initiate leveling sequence. The leveling sequence can employ software to initiate patterning. With the patterning concluded, a robot can be used to remove both the printing array and the substrate.

FDM achieves the additional goal of not requiring any optical feedback, and thereby removing the design constraints that previously require a clear optical path between tips and a microscope. Achieving planarity can employ FDM, not just between a 2D DPN array and a substrate, but between any two objects where either one is compressible or flexible.

Although it may be possible to perform leveling only using two endpoint measurements of force, without calculating the derivatives or the rate of changes of the force, the two-point method may not result in satisfactory results at least in some cases. For example, in the situation illustrated in the upper right panel of FIG. 3C, the two-point measurements would provide the misleading impression that level is achieved. This is because in the second portions of the three curves, the slopes are the same. This misses the fact that the slopes vary elsewhere in these curves. Thus, the two-point measurements can be misleading or incomplete. FDM can account for this by giving a spectrum of information of the complicated compression characteristics of any materials.

Without measuring or calculating d′F/dz′, the two-point measurements also rely on iterative process of measuring two-points across many ranges of stage angles. By contrast, FDM can be automated to happen in a short time scale, such as milliseconds.

FDM can achieve a better precision than conventional methods, for example, with >>0.1 mN precision, and subsequently a reduced planarity measurement limit, for example, with measurable tilting of <0.004°.

Furthermore, it is noted that FDM advantageously does not need absolute reliable force measurements, as long as changes in the force are measured consistently. For example, the force sensor(s) does not necessarily need to be calibrated to known loads. This provides some flexibility in accounting for environmental noise, thermal drift, etc. For example, the measured force Fₘ could be the true value of the force Fₜ times a constant C, the derivative dFₘⁿ/dz=CdFₜⁿ/dz would still have a maximum at the same relative position of the two objects as dFₜⁿ/dz.

### FDM Compressible Elements

FDM can be used to level two substantially planar objects, where either one or both of the objects comprise a compressible material, a compressible element, or a flexible material/element.

For example, the array can include a backing and an array of tips disposed over the backing, and at least one of the backing, the tips, or the second object can be compressible. Alternatively, an array of cantilevers having tips thereon can be disposed over the backing, and the cantilevers can be flexible.

### FDM Rigid Mechanical Loop

The “mechanical loop” can be defined as the smallest point-to-point distance between the first object and the second object, such as the array to the substrate surface. When the array and substrate are not in contact, the shortest path between them forms a “C” shape. When they come into contact, they form an “0” shape. This mechanical loop is preferably made as rigid as possible. This can be achieved, for example, by making all except one components as rigid as possible. For example, if the tips are compressible, the backing and the substrate are made as rigid as possible, thereby more accurate measurements can be made without convoluting compressions from several components of the system.

A rigid mechanical loop can be included in the leveling system, with kinematically mounted non-moving components. A rigid mount can be included in the rigid mechanical loop. For example, the array and the substrate can both be rigidly mounted. For example, the substrate can be glued down to a glass slide, and the array can be fixed with magnets. Thus, only the tips or cantilevers compress/flex.

Without rigidly mounting an array, for example, with 3 points of rigid contact, it is possible that the device may rock back and forth, introducing additional coupled-Z motion complexity in addition to the scale's motion.

On the nanolithography platform (NLP) system by Nanolnk, this can include the mounting arm, the ceramic fixture, the stage frame, the instrument base, the X, Y, Z, Tₓ, T_{y} stage stack, and the substrate plate. In accordance with embodiments disclosed herein, the force sensor(s) can be either immediately above the array or immediately below the substrate, or anywhere in the mechanical loop.

In one embodiment, a rigid, gravity-friendly, removable kinematic mount is provided. A modification of the existing self-leveling gimbal fixture arm can be made to enable rigid mounting of a 2D array. Three magnets can be glued to the back of an array handle. The three magnets later can adhere to the underside of a rigid rectangular frame of magnetically permeable material. This aims to ensure that all monitored motion and forces are restricted to the elements of interest, and that there are no tangential system components flexing and bending to obscure the data.

### FDM Examples

There are several ways to begin implementing the FDM to achieve planarity between two objects. The system can include an accurate and precise force sensor(s), and an accurate and precise actuator. The actuator can be, for example, a Z-stage.

In one embodiment, FDM is performed by monitoring force readings while actuating the actuator to drive the array or the substrate. For example, the load is continuously measured, or measured at each actuating step, while the Z-stage is actuated upward toward the 2D array. In an automation process, FDM can be performed by real-time monitoring of force readings (with a high sampling rate for data acquisition) as the Z-stage moves the substrate into contact with an array.

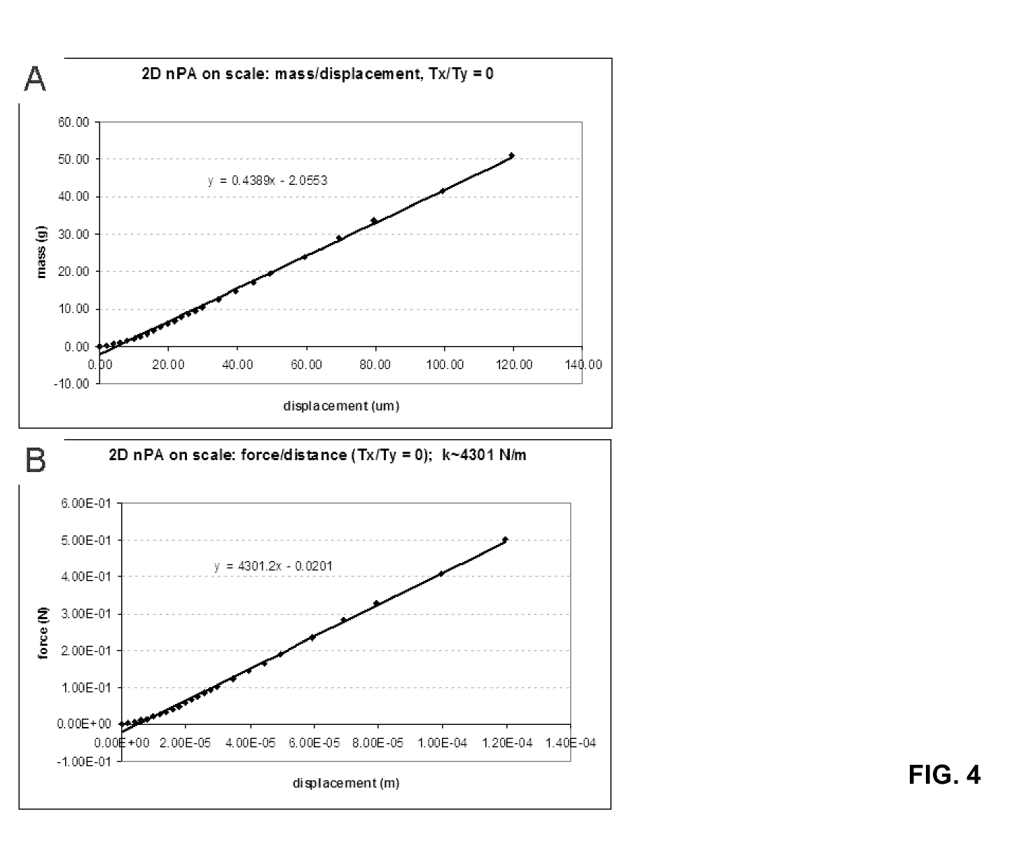

FIGS. 4A and 4B show force-distance curves for the 2D nPA interacting with the substrate at its initial planarity (no Tₓ, T_{y} adjustments). To obtain the data in FIG. 4A, an epoxy “pre-leveled” array is brought into contact with the surface. Displacement of 0 μm indicates the point at which the scale started reading a load measurement. The stage is then continued to be actuated to compress the cantilevers by the amount shown. Since the cantilevers have only 15 μm freedom of travel, while actuation can be achieved, for example, 120 μm, it is clear that the scale begins giving way (e.g., started compressing) at some point, and the initially dual-spring system goes back to a single-spring system.

FIG. 4B illustrates similar data, but mass is converted to force, and displacement is converted from μm to m. As shown in FIGS. 4A and 4B, the collective k of an array is influenced strongly by the scale. The value of k can be somewhat higher than the scale.

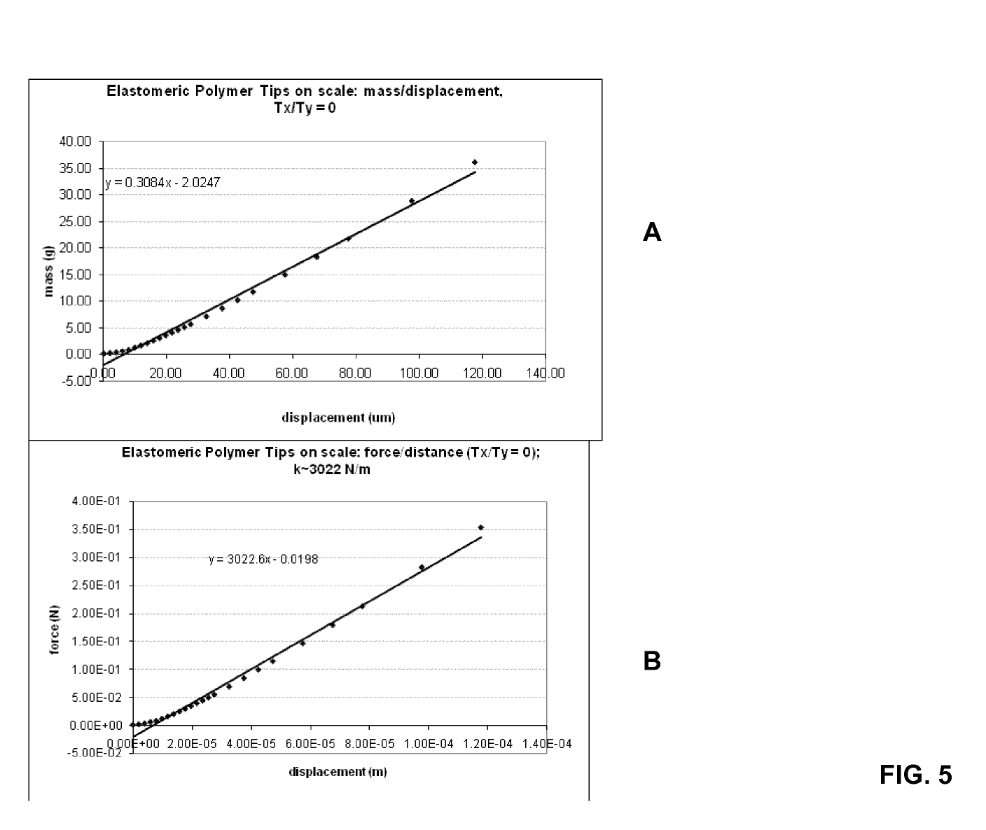

FIGS. 5A and 5B illustrates similar measurement for an EPT array (fabricated on a transparent glass backing-substrate). As shown, the collective k of this array is also influenced strongly by the scale. The k value of the array is slightly higher than the scale. For example, ˜k_{2D nPA}=4301 N/m, ˜kₑₗₐₛₜₒₘₑᵣ=3022 N/m. The elastomeric tips can be slightly more compressible than the cantilevers.

According to the equations supplied below and the measurements obtained in FIGS. 4A-5B, various spring constants k can be obtained:

$${k}_{2 DnPA} = \frac{{k}_{scale} \cdot {k}_{collective}}{{k}_{scale} - {k}_{collective}} = \frac{6000 \cdot 4301}{6000 - 4301} = 15 \text{,} 188 ( \frac{N}{m} ) , and$$

$${k}_{EPT} = \frac{{k}_{scale} \cdot {k}_{collective}}{{k}_{scale} - {k}_{collective}} = \frac{6000 \cdot 3022}{6000 - 3022} = 6088 ( \frac{N}{m} )$$

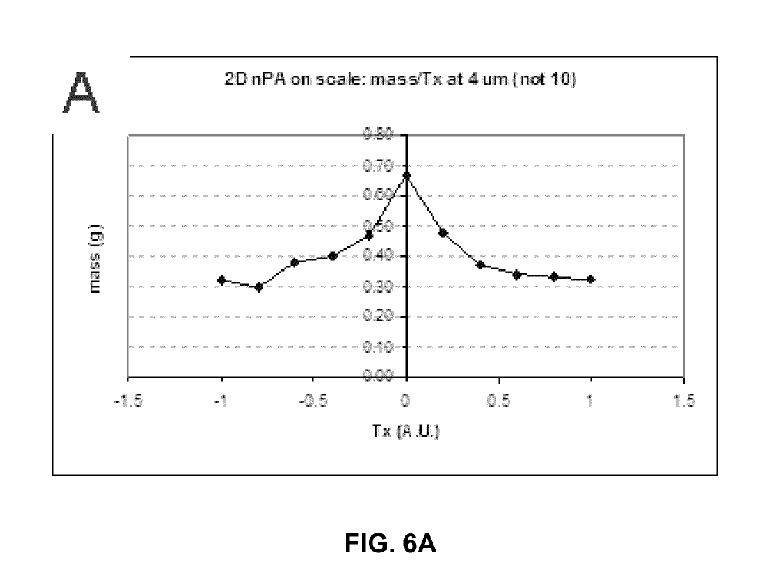

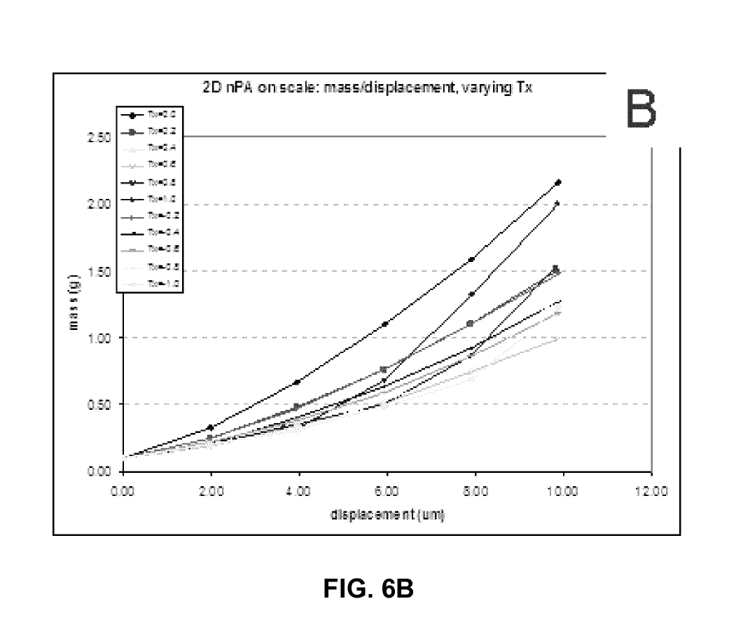

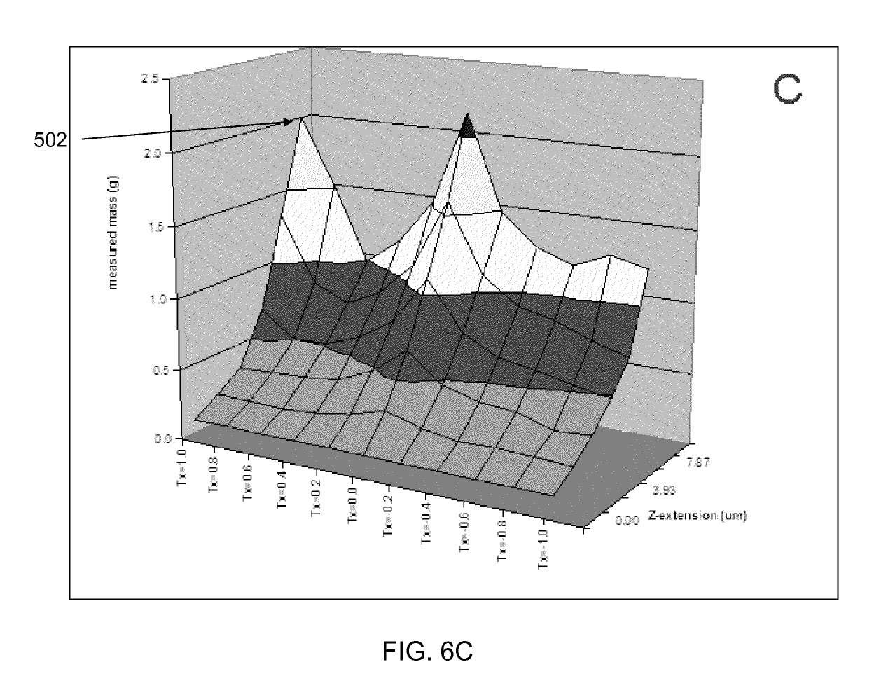

FIGS. 6A-6C show force curves for the 2D nPA collected at various Tₓ positions. Specifically, FIG. 6B shows the comprehensive data set of the force distance curves at a variety of Tₓ tilt positions, and with limited actuation (0-10 μm only). FIG. 6C shows this same data set plotted in 3D. FIG. 6A shows the cross-section of FIG. 6C at a Z-extension of 4 μm. From this data set, it can be seen that the dF/dz slope is steepest at Tₓ=0, where the array is the most level.

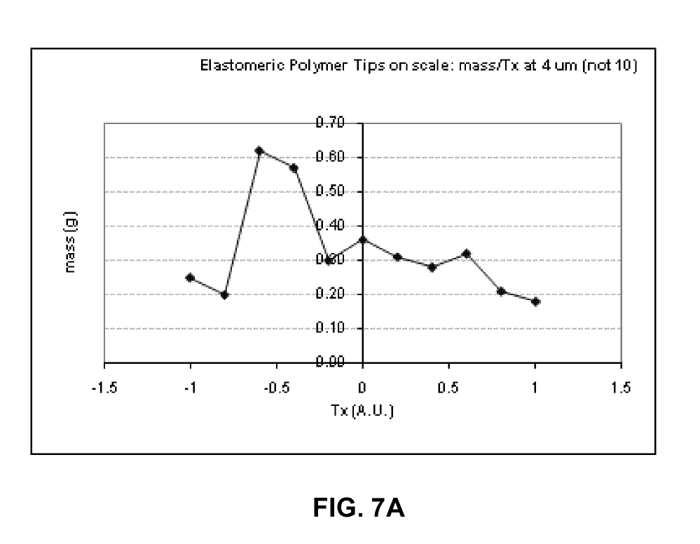

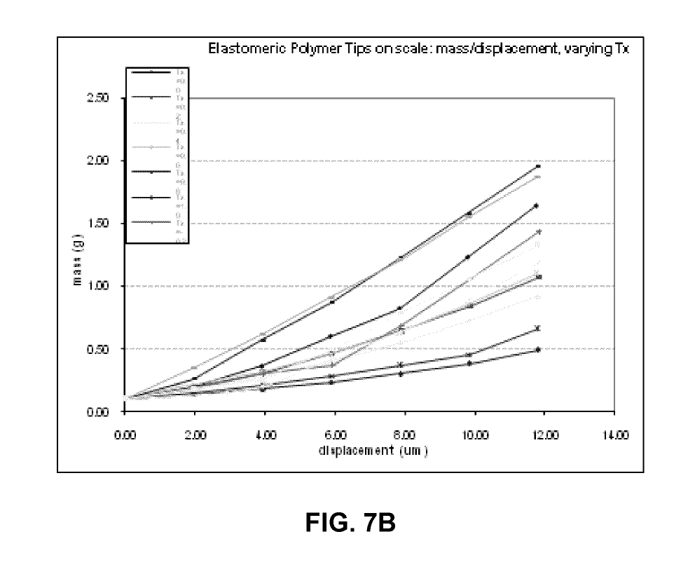

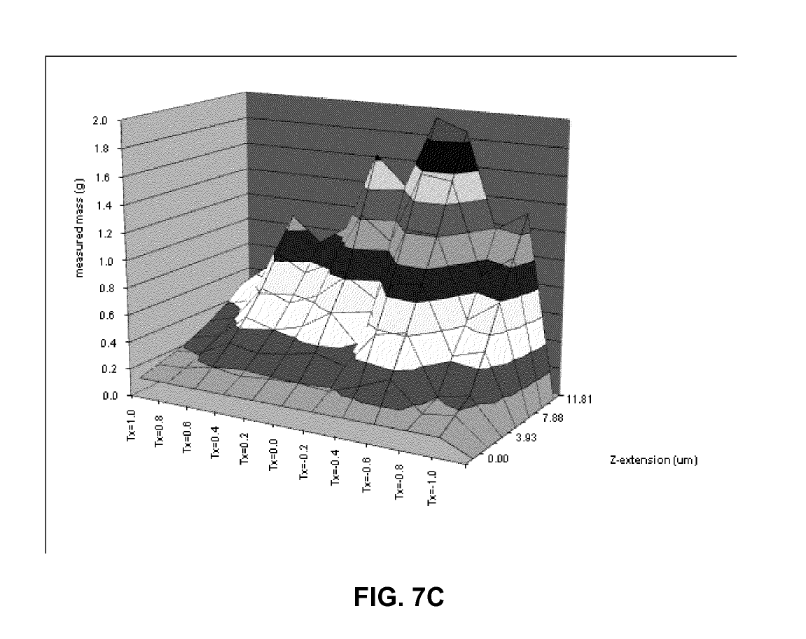

FIGS. 7A-7C show force curves for the EPT array collected at various Tₓ positions. Specifically, FIG. 7B shows the comprehensive data set, FIG. 7C shows this same data set plotted in 3D, and FIG. 7A shows the cross-section of FIG. 7C at a Z-extension of 4 μm. There is a dF/dz maximum at −0.6<Tₓ<−0.4. This suggests that the array shifted slightly after initial pre-leveling with epoxying, which as discussed above has known errors. Indeed, this mechanical fixturing is considered preliminary, non-robust, and the epoxy technique is prone to volume distortion. Embodiments disclosed herein help overcome these drawbacks.

Thus, the generalized FDM method works for the two different arrays of different design and materials shown in FIGS. 6A-7C.

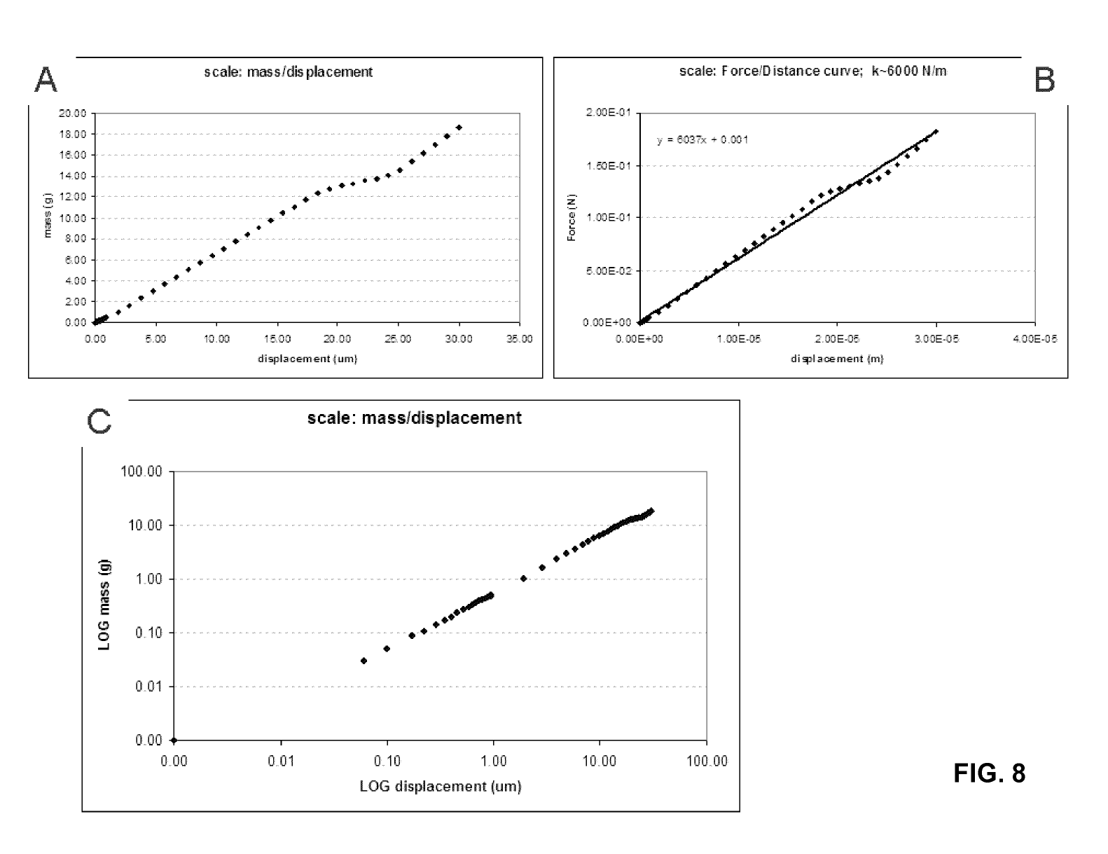

FIGS. 8A-8C illustrate the force-distance curve measurements of the OHaus scale alone against the rigid probe mount arm. This verifies that the scale itself behaved in a linear way, and therefore would not compromise any subsequent system measurements.

Various algorithms can be employed for the automation process. First, the relative distance between the array and the surface is varied, for example by a step motor. This step is referred to as the “Z-extension.” Next, the force profile is recorded as a function of the distance Z. A derivative is calculated from the force profile. The titling in the x and y directions, Tₓ and T_{y}, are adjusted until a position is found to have the maximum force. In one embodiment, if the force derivative profile decreases, the program will instruct the system to move to an opposite direction in Tₓ or T_{y}, thereby finding the maximum value faster.

Instead of evaluating the force derivative of the distance Z, the force derivative of time can be evaluated while moving z, φₓ, and φ_{y} at constant rates.

Finite Element Analysis (FEA) predictive method can be employed in accordance with embodiments disclosed herein. When material characteristics are known beforehand, the system can anticipate what a given force-distance curve should look like for a given orientation. For example, the derivation above reveals k_{2DnPA}=15,188. If the system were to take a force-distance curve of an identical device where k=10,000, one would know that the device is out-of-level. If this were performed at two different known φₓ and φ_{y} orientations, the system could then calculate and predict where φₗₑᵥₑₗ would be. It could go there in one step.

In some embodiments, pre-characterized devices can be employed. Different arrays (2D nPA, EPT, etc.) can be pre-characterized at the factory so that customers receive a device with a “known” k=a+/−b. This k value is then entered into software and used in a predictive method. An array arrives with known k, and subsequent FDM readings inform how it should be leveled more quickly and efficiently.

Any of these algorithms allow the user to monitor and compensate both the applied force and the planarity on-the-fly for any objects when they are in contact. These objects can be made of any materials. For nanopatterning, this provides not only force-feedback but also planarity-feedback. For the case of writing dot arrays, each written dot provides its own force-distance curve which can be monitored, compared to the one preceding, and Z, X, Y, φₓ, and/or φ_{y} corrections can be applied before the next dot.

The speed of the system may be limited by the data acquisition rate and precision of the force sensor(s), and the actuation speed and acceleration profile of the actuator (Z-stage).

Moreover, the FDM method provides automation means to correct for “non-ideal boundary conditions.” One example is seen in FIG. 6C. As the device gets progressively more and more out of level, the corner of the 2D array starts hitting the substrate. This corner can be part of the silicon handle wafer, and can be much more rigid than the SiN cantilevers. Thus, there is an anomalous force spike 502. However, this can be accounted for according to the method described in FIG. 3C. When taking the derivative of the force curve—even a non-linear one—the resulting motion should still be continuous. A discontinuity can imply an obstruction, which would prompt the system to go back and try a different φ_{x,y} orientation. Some thing moving nonlinearly . . . higher order derivative will manifest discontinuity in FIG. 3C.

The FDM method can be used even in the case of arbitrarily small z-extensions. With sufficient precision, z-extensions can be only several hundred nanometers (or smaller), and a difference in dF/dz slope versus planar orientation can be revealed. This is desirable for minimizing pre-patterning surface contact time with inked tips. This is also desirable for minimizing the “obstruction encounters” described above. Note that the obstruction revealed by the peak 502 in FIG. 6C does not occur until ˜z=6 μm. The sensitivity of the system employing the FDM can be very useful if arrays constructed out of very delicate materials are used, such as materials that have a low upper-bound to their force tolerance. Small Z-extensions would enable a “feather touch” type leveling scenario.

In one example, a modified mount on the NLP is employed to rigidly mount a 2D array. The actuator can be the NLP Z-stage. The X and Y stages can be used to pre-position the scale under the array. Tₓ and T_{y} are varied according to the data in FIGS. 6A-7B in order to illustrate the different dF/dz behavior at different planarities.

A pocket scale (e.g., Ohaus YA102, 0.01 g precision) can be mounted on the NLP stage plate as the force sensor. Measurements can be made with a known “nearly level” device, as achieved using an epoxy procedure. For example, the array can be left on the substrate, and then brought up to magnets on the mounting arm that are pre-loaded with epoxy. After a few minutes' wait time (e.g., the curing time of the epoxy), the stage can be retracted, and the near level surface is obtained. Other errors can result, for example, from that the epoxy can go through volume distortion. Embodiments disclosed herein can achieve leveling without the epoxy procedure.

All instrument motions can be coordinated via the NLP software. Force readings can be taken directly from the digital display of the Ohaus scale. The scale can be pre-calibrated according to factory procedure via a known 100 g mass.

The Ohaus pocket scale can be pre-characterized according to the plot in FIGS. 8A-8C. In conjunction with FIGS. 4A-5B, FIGS. 8A-8C show that the spring constant of the scale itself (k_{scale}˜6 k N/m) is within an order of magnitude of the collective spring constants of both a 2D nPA and an EPT array. The collective spring constants shown in FIGS. 3B and 4B are related to the scale by Hooke's law for springs in series as:

$${k}_{collective} = \frac{1}{\frac{1}{{k}_{scale}} + \frac{1}{{k}_{array}}} = \frac{{k}_{scale} \cdot {k}_{array}}{{k}_{scale} + {k}_{array}} \\ ⇒ F ( z ) = - {k}_{collective} \cdot z = - ( \frac{{k}_{scale} \cdot {k}_{array}}{{k}_{scale} + {k}_{array}} ) \cdot z$$

One result of this relationship is, unlike methods relying on optical measurements of cantilever deflection, that the movement of any given part of the system (cantilever, tip, etc.) cannot be assumed to move the same amount as the Z-stage actuation.

In some embodiments, a tripod configuration is used for the measurement of force, where the force is measured from, for example, three different points arranged geometrically symmetric about the center of the patterning array. The differential between the three sensors creates a vector that describes the device planarity. The device is level when there is no vector and the force is balanced at all three sensors.

The configurations of the system can be carefully monitored/controlled for temperature, relative humidity, vibration, etc., to mitigate spurious readings and/or drift due to environmental changes. For example, environmental enclosures can be used to keep the system at a constant temperature.

### Intermediary Objects

In some embodiments, the array does not touch down on the substrate surface, but touches down on an intermediary object which matches the substrate planarity. This approach prevents unwanted inking of the substrate. The intermediary object can be a flat slab device. The intermediary object can be employed in embodiments without the force derivative methods.

The intermediary object can also be composed of, for example, three balls discussed above in the tripod configuration. The three balls can be placed under three corners of the device providing three different points of contact. The force derivative curves are measured independently as each corner touches each ball. The device is considered planar when the maximized force derivatives curves are equal. The balls do not necessarily touch the tips, but can come into contact with a sacrificial outside perimeter of the array. The three balls can be part of a rigid, connected frame.

Alternatively, only one ball can be employed. The single ball can be “picked-and-placed” by a robotic arm. This device, termed the “ball-spacer device” is discussed in detail below.

The intermediary balls/objects can be pre-fabricated at specific positions on the substrate. These intermediary objects can be coarsely pre-leveled according to a passive self-leveling gimbal device as described in the cited references. Thus, in a leveling system, both the balls and a passive self-leveling gimbal device can be employed.

In some embodiments, the balls are not on the substrate but are actually incorporated into the array itself for use with a self-leveling gimbal (see, e.g.,

A sufficient force can flex the balls back into the soft backing material allowing the tips to touch the substrate surface.

### Overview of Ball-Spacer Method

The ball-spacer method is designed to level an arbitrary array to an arbitrary substrate to within defined parameters. It is designed to be fully automated and minimize user involvement throughout the process. It further aims to optimize the process in terms of the method's core metrics: (1) leveling precision (repeatability), (2) leveling accuracy (ultimate co-planarity between the two objects), and (3) process time.

The ball-spacer method achieves this automation through a custom software interface (AutoLeveler) and scripting language (LevelScript). In some embodiments, a user may have control over most system parameters, and can construct LevelScripts accordingly. However, in commercial implementations, the ball-spacer method may allow focus of this control and simplify the interface in the interest of ease-of-use. The ball-spacer system may also be used to determine spring constants of arrays, and to level microcontact printing templates, Nanolmprint Lithography devices, or any other such devices.

### Details of Ball-Spacer Apparatus

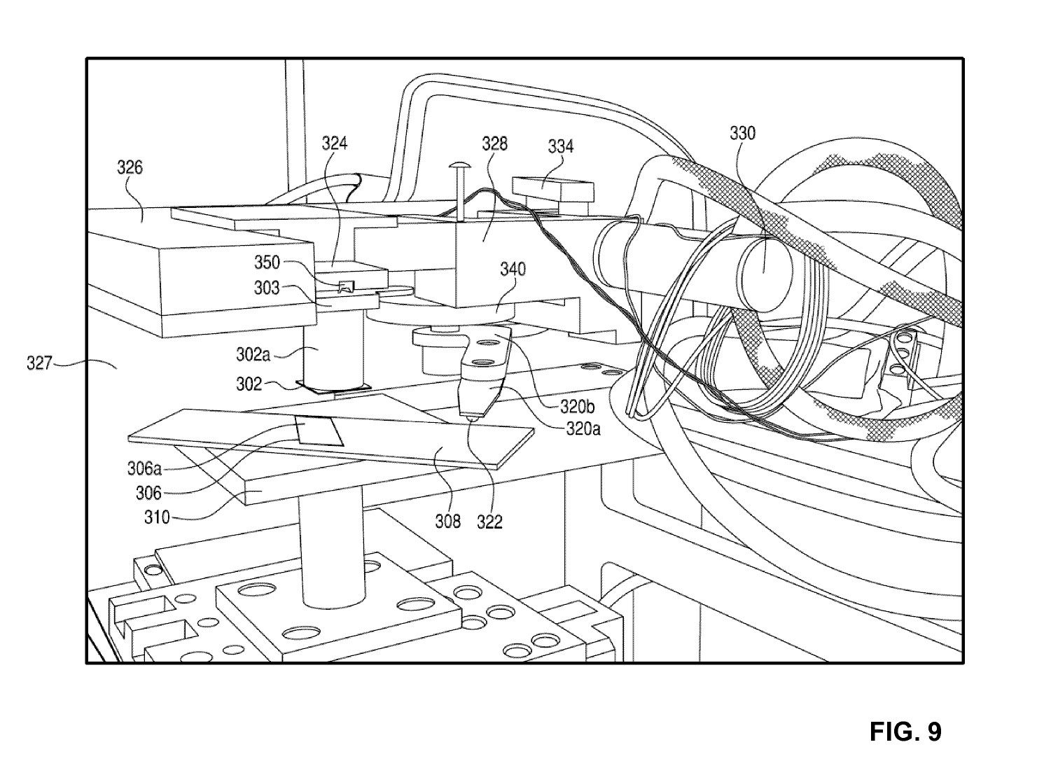

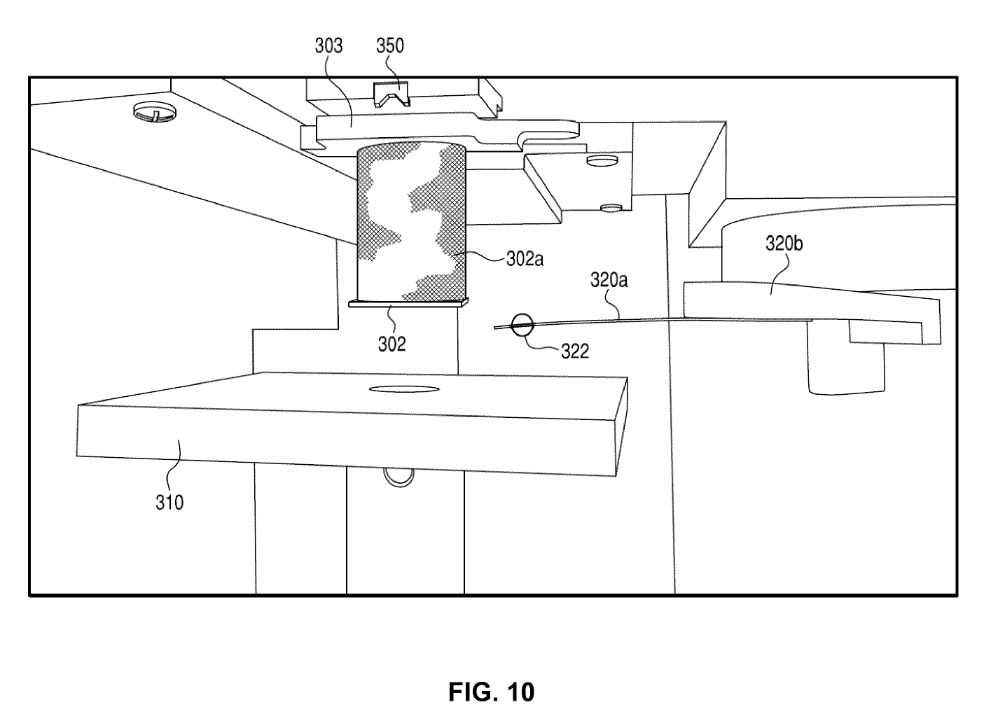

In an embodiment of the invention, depicted in FIGS. 9 and 10, an apparatus 300 is provided, the apparatus being configured to level an array of microscopic pens 302 to a surface 306a of a substrate 306. The apparatus includes a controllable arm 320 having a ball 322 on an end thereof. The controllable arm 320 is configured to move the ball 322 to a plurality of positions between the array 302 and the substrate surface 306a. The positions may correspond to the corners of the array 302. The apparatus includes a force sensor 324 configured to measure a force exerted on the array 302 or the substrate surface 306a at each of the plurality of positions of the ball 322. The apparatus further includes one or more actuators (not shown) configured to drive the array 302 or the substrate 306 to vary a relative distance and a relative tilting between the array 302 and the substrate surface 306a. The apparatus may include a controller configured to (i) determine a planar offset of the array 302 with respect to the substrate surface 306a based on a distance traveled by the array 302 or the substrate 306 at each of the plurality of positions before the force measured by the force sensor 324 exceeds a given threshold and (ii) initiate a leveling of the array with respect to the substrate using the one or more actuators based on the planar offset.

The array of microscopic pens 302 is not limited to any particular design. In the apparatus 300, the array 302 is preferably a two-dimensional array of pens, through the ball-spacer apparatus may be used with a one-dimensional array. The array may comprise tips or probes. It may comprise cantilevers with or without tips. The array may be a traditional two-dimensional nano PrintArray (2DnPA). The array may also be an HDT (High Density Tips) polymer array, which is generally more challenging to level than the traditional 2DnPA because it is not possible to use optical leveling methods for such arrays. Other arrays can include arrays of hard tips with soft backing, thin membranes of tips with no backing, etc.

The array 302 may be mounted on an array handle 303 using any method that does not substantially effect the planarity of the array 302. For example, the array 302 may be mounted to the array handle 303 using a low-curing-volume-deformation epoxy, for example Devcon “5 Minute Epoxy Gel.” The array 302 may be affixed directly to the array handle 303, such as, for example, when the array is a 2DnPA, or may be attached to a backing material which is affixed to the array handle 303, such as when the array is an HDT array. The backing material can be, for example, glass. Preferably, the arrays 302 are configured to use the same generic attachment handle 303 regardless of the type of array. The array handle 303 may be configured to be attached to a standardized kinematic mount, as discussed below. The array handle 303 may be structured as a hollow frame so that the tips or probes 304 of the array 302 are visible by the NLP optics. The array handle 303 may include a number of wings or tabs, which allow the array handle to be handled by a user. The array handle 303 may include a number of spherical magnets embedded therein, the spherical magnets corresponding to mounting areas on the kinematic mount. The array handle 303 may include three such spherical magnets. Such magnets can aid in the storage and safekeeping of arrays.

In some embodiments, an array spacer 302a is provided between the array 302 and the array handle 303. The array 302 and array handle 303 may be attached to the array spacer 302a in the same way that the array 302 may be attached to the array handle 303, as described above. The array spacer 302a allows the array 302 to be located at a variety of vertical positions above the substrate 306.

Alternatively, a load cell adjustment end piece 303a may be provided. The end piece 303a may include a number positions at which the array handle 303 can be attached, such that the vertical position of the array is controlled based on the position at which the array handle 303 is attached. The end piece 303a may provide precise control over the position of the array relative to the vertical resting position of the ball 322.

In some embodiments, the array 302 includes leveling portions made of a material which are harder than the material of the array 302.

The substrate 306 may be any object that it is desirable to level with the array 302. For example, the substrate 306 may be an object on which a pattern is to be formed. The substrate may be located on a mount slide 308, which itself may be located on a stage plate (“Z-stage”) 310. The mount slide 308 may be made of glass. The substrate 306 may be attached to the mount slide 308 using a small amount of adhesive, such as super glue. It is preferable for the substrate 306 to be able to be removed from the mount slide 308 without damage to the substrate 306. The mount slide 308 may be attached to the stage plate 310 using spring clamps. The stage plate 310 may be movable in a vertical direction to various Z-positions by an actuator, such that the actuator provide the variation in relative distance and relative tilting between the array 302 and the substrate surface 306a. For example, the actuator(s) may control a tip and a tilt of the stage plate 310. The actuator may be configured to move the stage plate 310 in either a stepwise or a continuous fashion. If a magnetic kinematic mount is used, as discussed below, the stage plate is preferably made of a non-ferrous material, so as not to disrupt the force sensor 324. In a preferred embodiment, the stage plate is vacuum stage plate, and the substrate is attached to the stage plate using the vacuum created by the vacuum stage plate.

The controllable arm may include a flexible portion 320a and a rigid portion 320b, as shown, for example, in FIG. 10. The flexible portion of the arm holds the ball 322, such that the ball is able to be moved in a vertical direction between the array 202 and the substrate surface 306a. The flexible portion 320a flexes when a force is exerted on the ball 322 by the array 302 or the substrate 306. In preferred embodiments, the flexible portion 320a is long enough to minimize clearance issues and prevent interference with motion of the array 302 and/or the substrate 306a.

The controllable arm 320, and/or the flexible and rigid portions 320a, 320b thereof may be exchangeable to allow compensation for different thicknesses of the array 302 and/or the substrate 306. The controllable arm 320 may be configured such that, even when the controllable arm 320 and/or the flexible and rigid portions 320a, 320b are exchanged, the ball may remain at the same R-theta position so as to not have a detrimental effect on previous calibrations. For example, when the arm 320 is exchanged, the difference in the R-theta position may be the same ±50 μm, and preferable ±10 μm. Thus, after a controllable arm 320 is exchanged for a new controllable arm 320, the ball 322 may be located in the same position in the plane parallel to the array 302 and the substrate surface 306a, but in a different vertical position. In preferred embodiments, the length of the arm is capable of being precisely controlled and measured, such that this length may be included in leveling calculations. In preferred embodiments, the flexible portion 302a is longer than the rigid portion 320b. In preferred embodiments, the flexible portion 320a is made of a non-magnetic material. In embodiments where the substrate 306 is moved and the array 302 is stationary, the flexible portion 320a may be set at a slightly downward angle relative to the plane of the array 302 and the substrate 306.

The ball 322 may be any ball with a size that allows it to be placed between the array 302 and the substrate surface 302a having a roundness and hardness that allow it to be used for precise distance and load measurements. The ball 322 is preferably a spherical ball. The ball 322 may be a sapphire ball. The ball 322 may have a diameter of 2000±0.080 μm. Preferably, the ball 322 is made of a material having a Mohs hardness of at least 9.

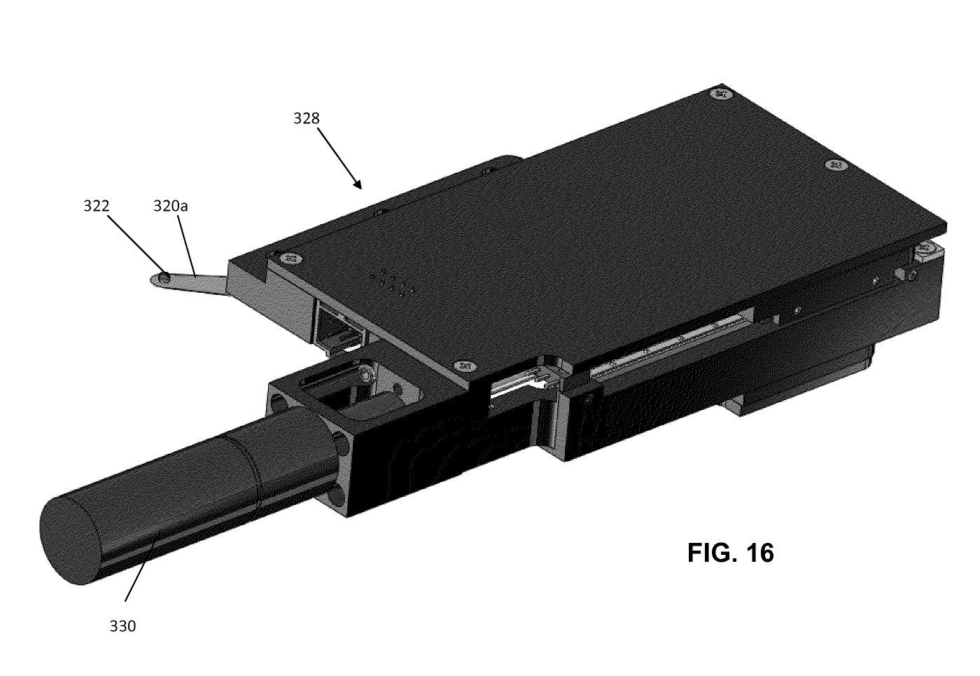

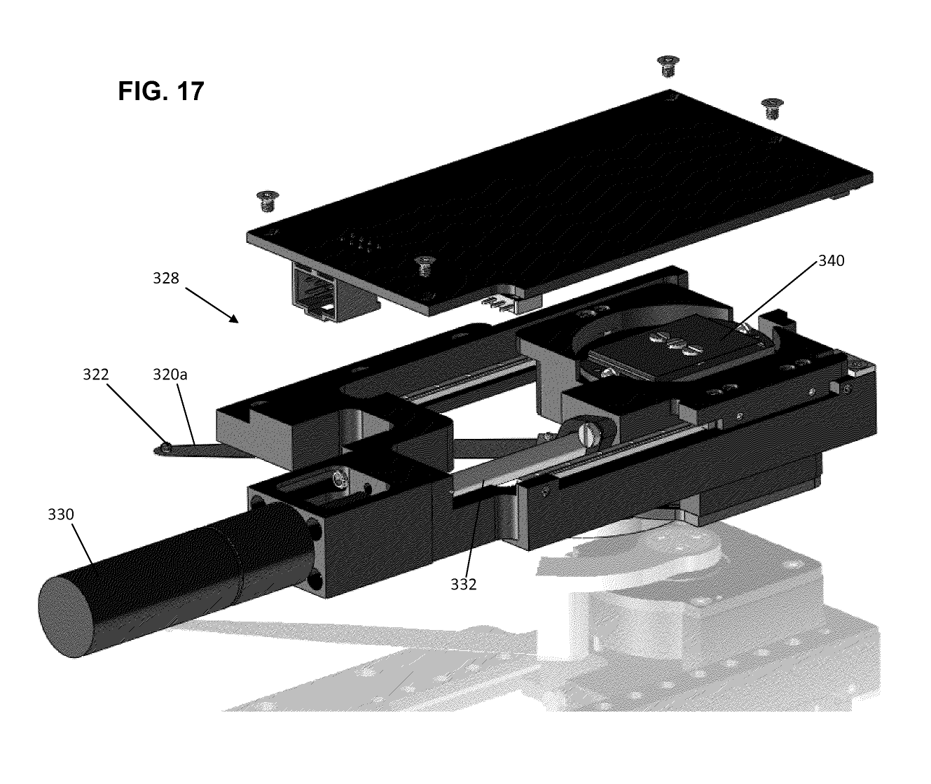

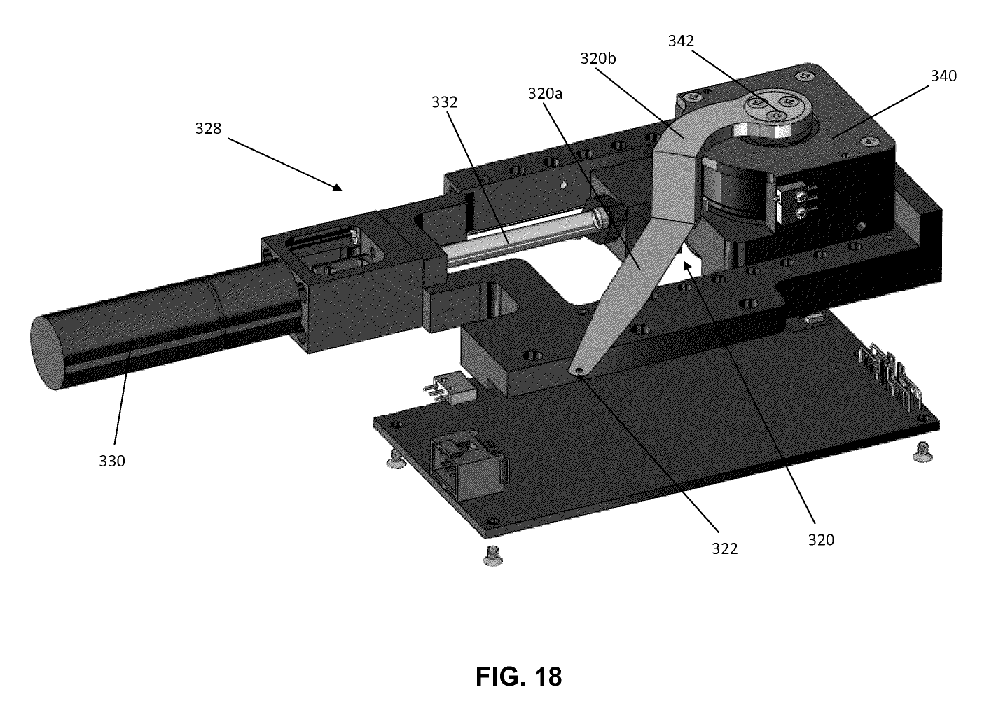

The controllable arm 320 may be moved using one or more motors. For example, a first motor may be a linear motor, or “R-motor,” 330 that moves the controllable arm 320 along an axis. A second motor may be a “theta-motor” 340, which can swing the controllable arm 320 in and out from between the array 302 and the substrate surface 306a. The R-motor 330 and theta-motor 340 may be located in or adjacent to a mounting frame 328. In FIGS. 9 and 16-18, for example, the R-motor 330 is shown to extend outside the mounting frame 328. In FIGS. 9 and 17-18, for example, the theta-motor 340 is shown to be located in the mounting frame 328. The controllable arm 320 may extend from below the mounting frame 328. The R-motor 330 may drive the controllable arm 320 to move linearly along an R-axis shaft 332. Linear shaft bearings (not shown) may be provided, which mitigate R-axis wobble. The theta motor 340 may drive the controllable arm 320 to rotate about a theta-axis shaft 342. The theta-motor 340 may include a fine adjuster on its shaft to allow for fine positioning of the ball 322 with respect to the array 302 in a vertical direction. Adjustments using the fine adjuster preferably should not affect the R-theta position of the ball. The mounting frame 328 is shown in detail in FIGS. 16-18.

This description of the motors is not meant to be limiting. The motors may be any combination of motors that is capable of moving the controllable arm 320 such that the ball 322 may be moved to a plurality of positions between the array 302 and the substrate surface 306a. Limit switches for both the R-motor 330 and the theta-motor 340 may be built into the mounting frame 328. The limit switches are preferably difficult to move or offset, so as to allow leveling calculations that are dependent on the zero-positions of the R-motor 330 and the theta-motor 340. The R-motor limit switch 334 is depicted in FIG. 9. The R-motor 330 and theta-motor 340 preferably produce little noise when idling. They preferably have high positional resolution and repeatability, as this affects how precisely the ball can be placed between the array 302 and the substrate 306.

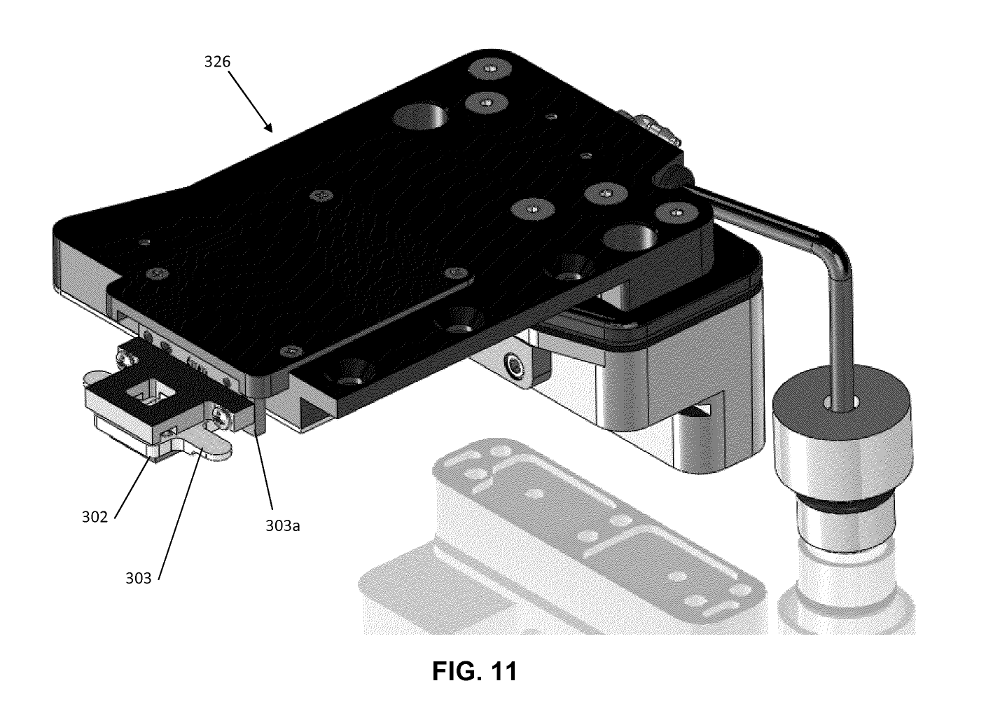

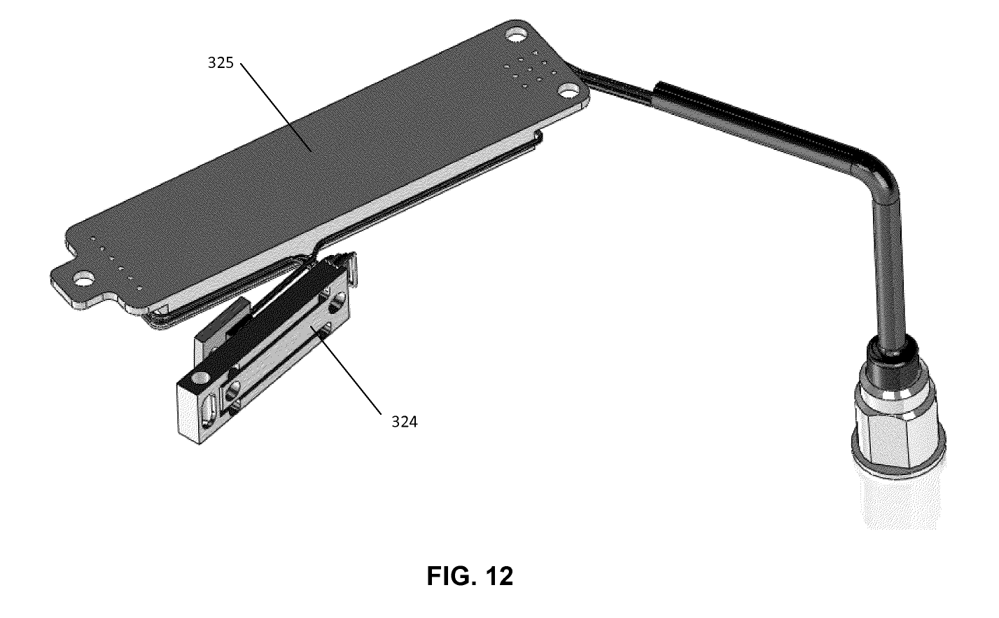

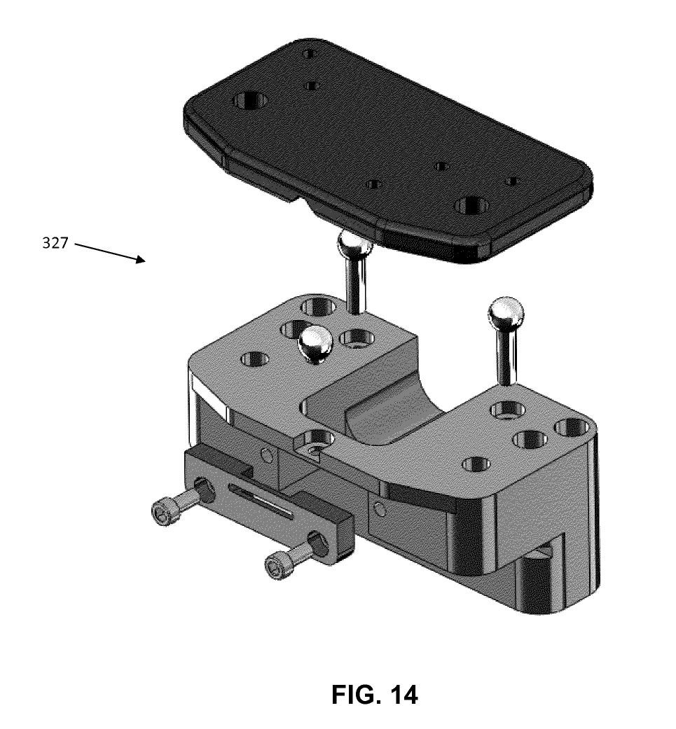

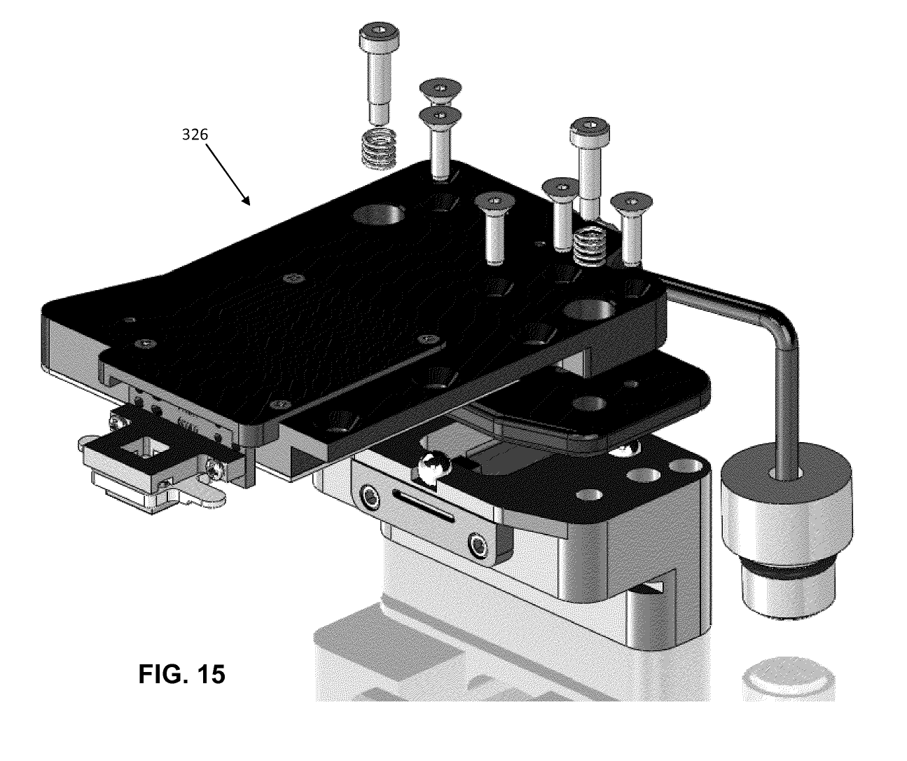

The force sensor 324 may be any device capable of measuring a force exerted on the array 302 or the substrate 306a. For example, the force sensor may be a load cell that is connected to the array 302 or the substrate 306a in such a way as to allow the force sensor to sense a force exerted on the array 302 or the substrate 306a. In FIGS. 9-11, for example, the force sensor 324 is shown to be located in a load cell chassis 326 located above the array 302. The load cell chassis 326 may be attached to a mounting block 327 of an NLP. It is preferable for the load cell chassis to be rigidly mounted to the platform that performs the patterning or printing. The load cell chassis 326 is shown in detail in FIGS. 11-15. Any wires, such as those shown in FIG. 12, are preferably well-shielded to minimize system noise.

In other embodiments, the force sensor may be replaced with any other device that is capable of detecting when contact is made between the array, the ball, and the substrate, such as, for example, an electrical sensor.

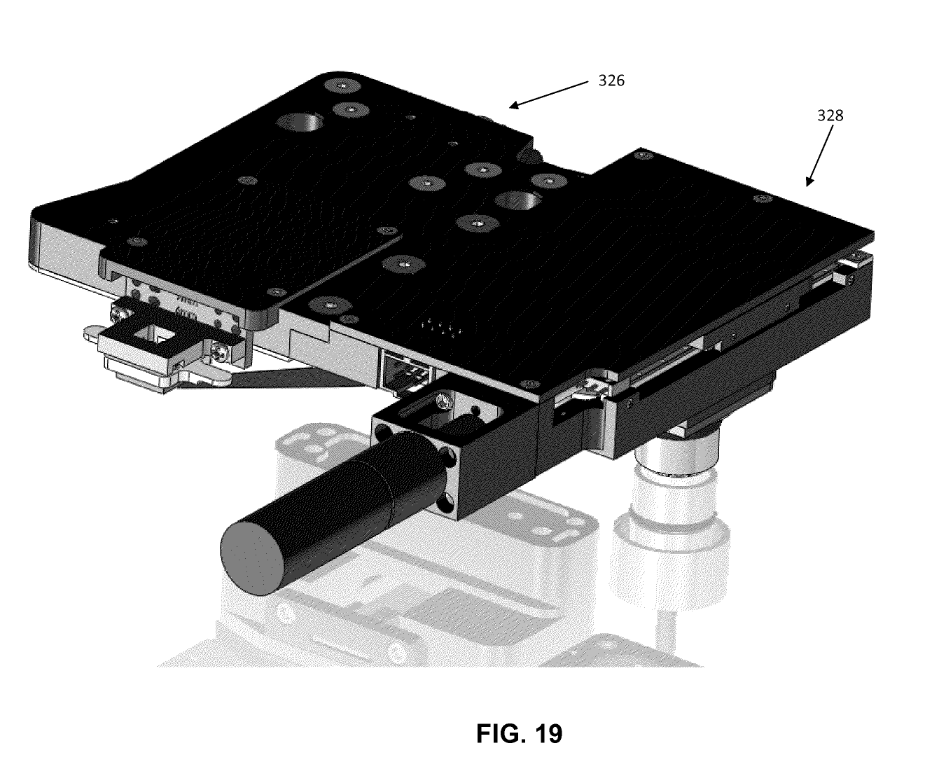

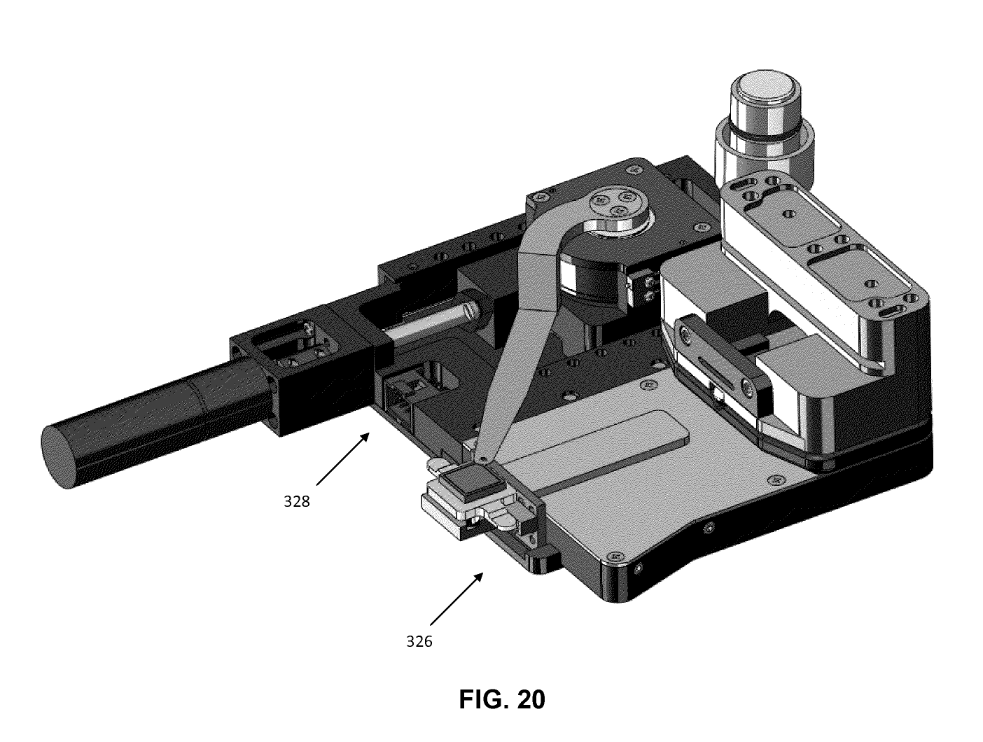

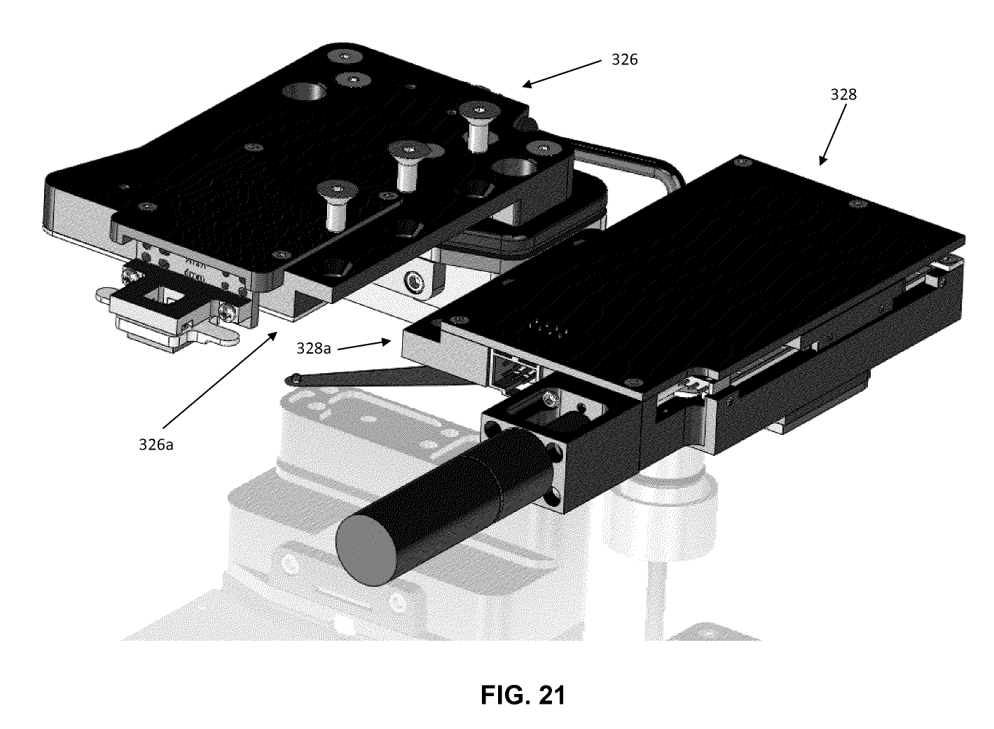

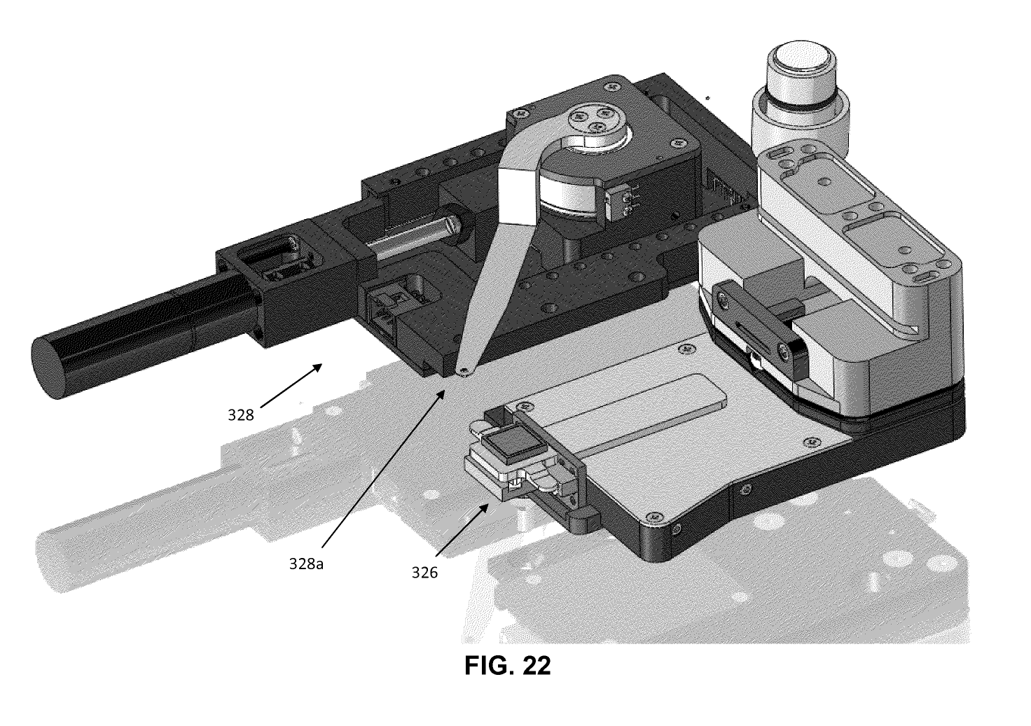

The mounting frame 328, which holds the controllable arm 320, may be mountable to the load cell chassis 326, as shown in FIGS. 19 and 20. As shown in FIGS. 21 and 22, edges 328a of the mounting frame 328 are configured to correspond with edges 326a of the load cell chassis 326 so that the mounting frame 328 may be rigidly attached to the load cell chassis 326.

The force sensor 324 preferably has a low signal-to-noise ratio, and specifically, a low noise floor while floating in free air. For example, the noise floor of the force sensor may be 0.25 mg or less. The force sensor 324 preferably has a load limit that balances the need for range and resolution. For example, the force sensor 324 may have load limit between 10 g and 30 g. Preferably, the planarity of the force sensor 324 does not change dramatically when the force sensor 324 is loaded and thus deflects in the vertical direction. The force sensor 324 may have, for example, a parallelogram design that prevents a dramatic change in planarity. The force sensor 324 may be, for example, a load cell, such as those manufactured by Strain Measurement Devices.

The controller in the ball-spacer apparatus may be a computer. The controller may include drivers and other connection hardware for controlling the controllable arm 320 and the actuators. The controller may be mounted on the side of the frame of an NLP. Power supplies for the controller may be placed away from the rest of the system to decrease noise that may have an adverse effect on other system components.

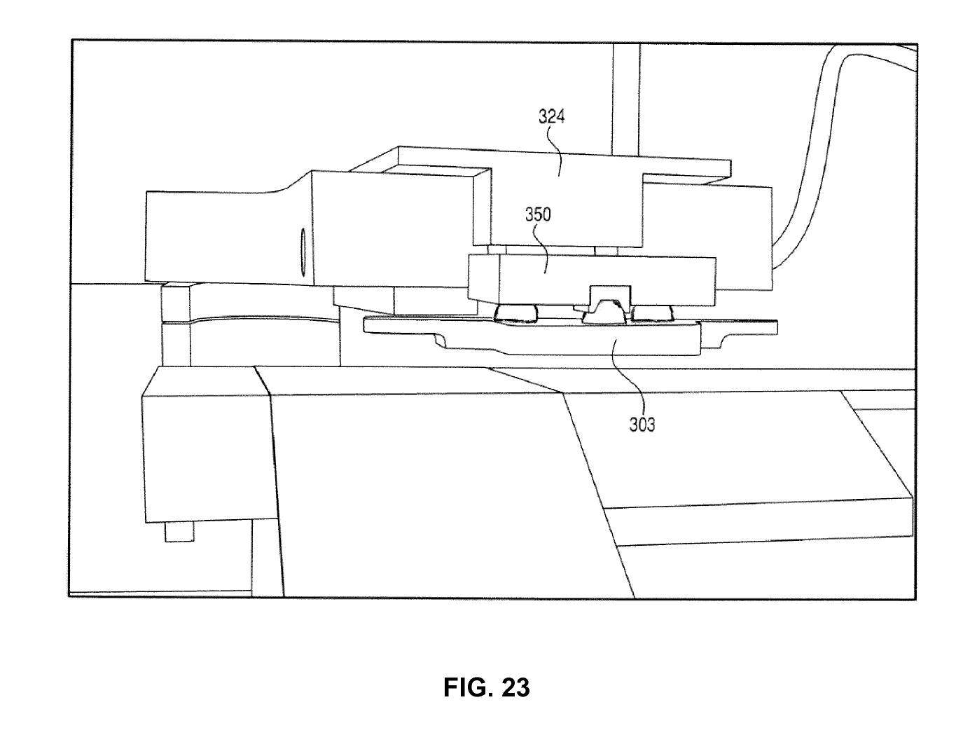

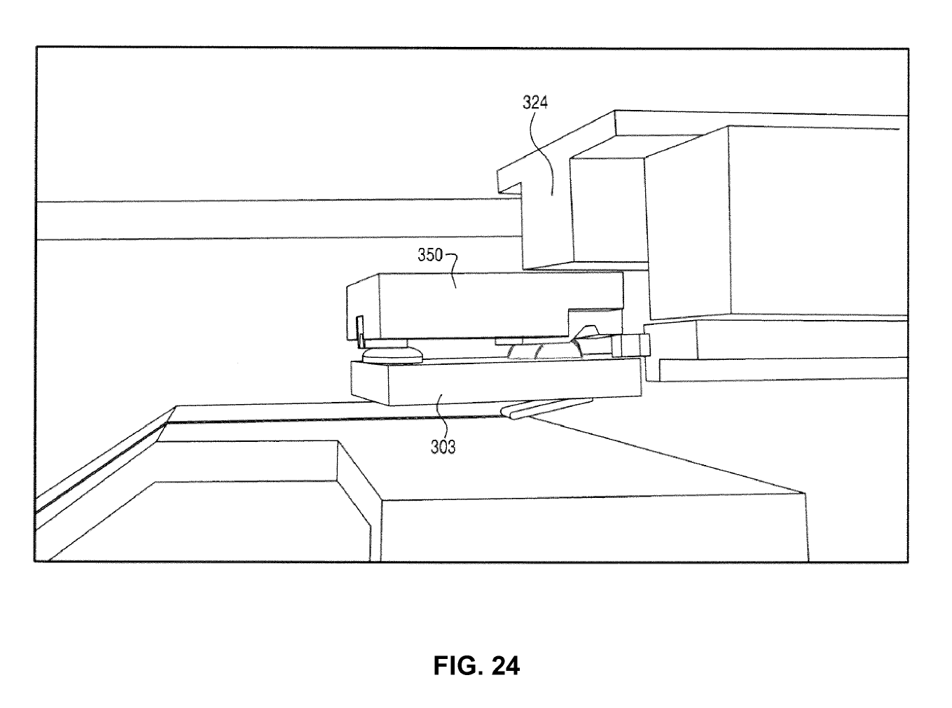

In some embodiments, the ball-spacer apparatus includes a kinematic mount that allows the array 302 to be mounted to the force sensor 324. The kinematic mount may be a magnetic kinematic mount 350, as shown in FIGS. 23 and 24. The magnetic kinematic mount 350 includes a number of mounting areas which correspond to spherical magnets embedded in the array handle 303. The kinematic mount 350 may be structured such that the NLP optics can still see down to tips or probes 304 located on the array 302. For example, the kinematic mount 350 may be structured as a square frame.

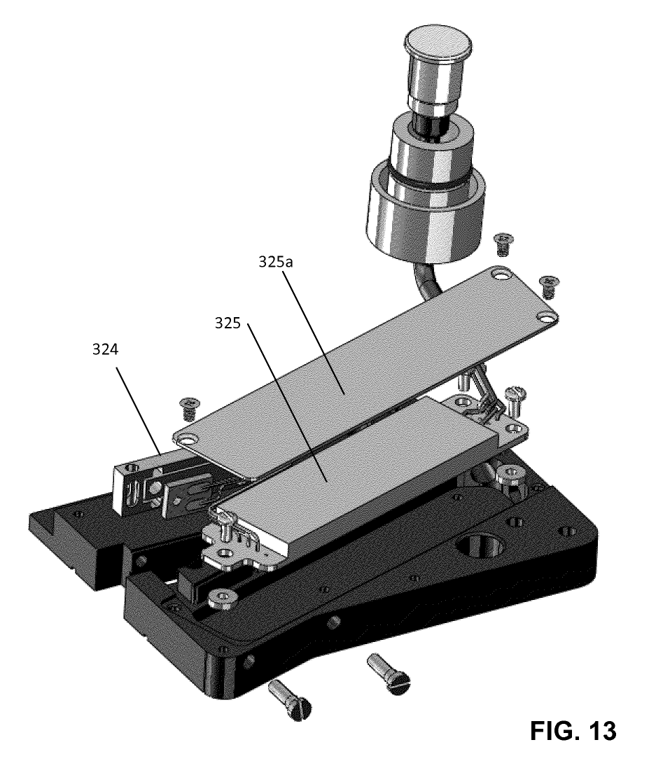

The ball-spacer apparatus may also include a load cell digitizer 325, as shown in FIG. 12. The load cell digitizer 325 can convert the signal from the force sensor 324 into a signal that is readable by the controller. The load cell digitizer 325 may, for example, be a Mantracourt Model DSCH4ASC Digitizer, available from Mantracourt Electronics, Ltd. The load cell digitizer 325 is preferably isolated as much as possible from all sources of noise. The load cell digitizer 325 can receive power from battery source, such as a 12V lantern battery. The load cell digitizer 325 may, alternatively, receive power from a non-battery low-noise power supply, or any other suitable power supply. The load cell digitizer 325 may be located in the load cell chassis, as shown in FIG. 13. A cover 325a may be provided for electrical, acoustic, and or seismic shielding, damping, and insulation.

An environmental control subsystem may be provided specifically for the force sensor.

Vibration isolation may be provided in order to maintain the lowest possible noise floor for the force sensor.

### Details of Ball-Spacer Method

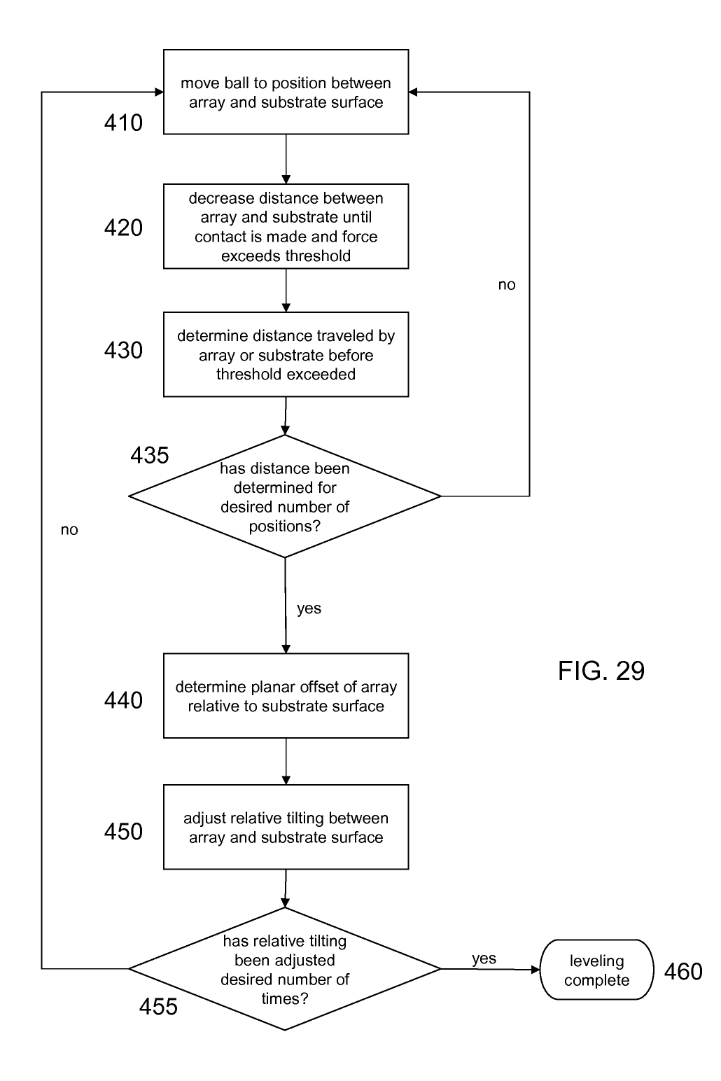

In an embodiment of the invention, a method is provided for leveling an array of microscopic pens to a surface of a substrate. The method is depicted in the flow chart in FIG. 29. In step 410, a ball 322 is moved to a first position between an array 302 and a substrate surface 306a. In step 420, the distance between the array 302 and the substrate surface 306a is decreased until contact is made between the array 302, the ball 322, and the substrate surface 306a and a force detected by a force sensor 324 exceeds a given threshold. In step 430, the distance traveled by the array 302 or the substrate 306 (“Z-position”) is determined. The steps 410 to 430 are then repeated a desired number of times 435. For example, the steps 410 to 430 may be performed twice for a one-dimensional array, or three times for a two-dimensional array. In step 440, the planar offset of the array 302 relative to the substrate surface 306a is determined. In step 450, the relative tilting between the array 302 and the substrate surface 306a is adjusted based on the determined planar offset to level the array 302 to the substrate surface 306a. The steps 410 to 450 may be repeated a desired number of times 455 to achieve the desired planar offset, at which point leveling is complete 460. Optionally, the planar offset may be calculated an additional time to ensure that the desired planar offset has been achieved.

The planar offset may be determined by calculating a difference, dZ, in the distances traveled by the array or the substrate at each of the plurality of positions, where the distance D between two positions is known. The planar offset dcp of the print array with respect to the substrate surface in term of angle is calculated as follows:

$$d ϕ = {tan}^{- 1} \frac{dZ}{D}$$

After the planar offset dφ is determined, the relative tilting between the array 302 and the substrate surface 306a may be adjusted based by adjusting the tilting of the array 302 and/or the substrate 306 by the amount of the planar offset dφ in a direction opposite the direction of the planar offset dφ. For example, assuming the actuator is configured to tilt in both an x direction and a y direction, two of the plurality of positions may be on a line in the x direction and two of the plurality of positions may be on a line in the y direction. The planar offset in the x direction may be calculated based on the value of dZ and D for the two positions on the line in the x direction. The planar offset in the y direction may be calculated based on the value of dZ and D for the two positions on the line in the y direction. Of course, if there are three positions between the array and the substrate, one of the positions may be in both the x direction line and the y directions line.

### Working Example of Ball-Spacer Method

An HDT array was leveled to a substrate surface using the ball-spacer method. Using a controllable arm, a sapphire ball was moved through three positions between the array and the substrate. The substrate was located on a stage plate that was movable in a vertical direction via an actuator. The force exerted on the array by the ball on the array was measured by a load cell located above the array. At each position, the stage plate, and thus the substrate, was moved toward the array until the ball came into contact with both the array and the substrate and the load cell measured contact. The substrate was moved continuously towards the array until contact was detected between the substrate, the ball, and the array. Contact was detected using a load cell taking continuous force measurements. The planar offset of the array with respect to the substrate surface was determined and the substrate was moved via the actuator to adjust the relative angle between the array and the substrate to correct for the planar offset. The process was repeated a second time to determine the new planar offset for the same three ball positions, and the substrate was moved again to adjust the relative angle between the array and the substrate to correct for the new planar offset. After this process was performed, the array was sufficiently level to the substrate to perform lithography.

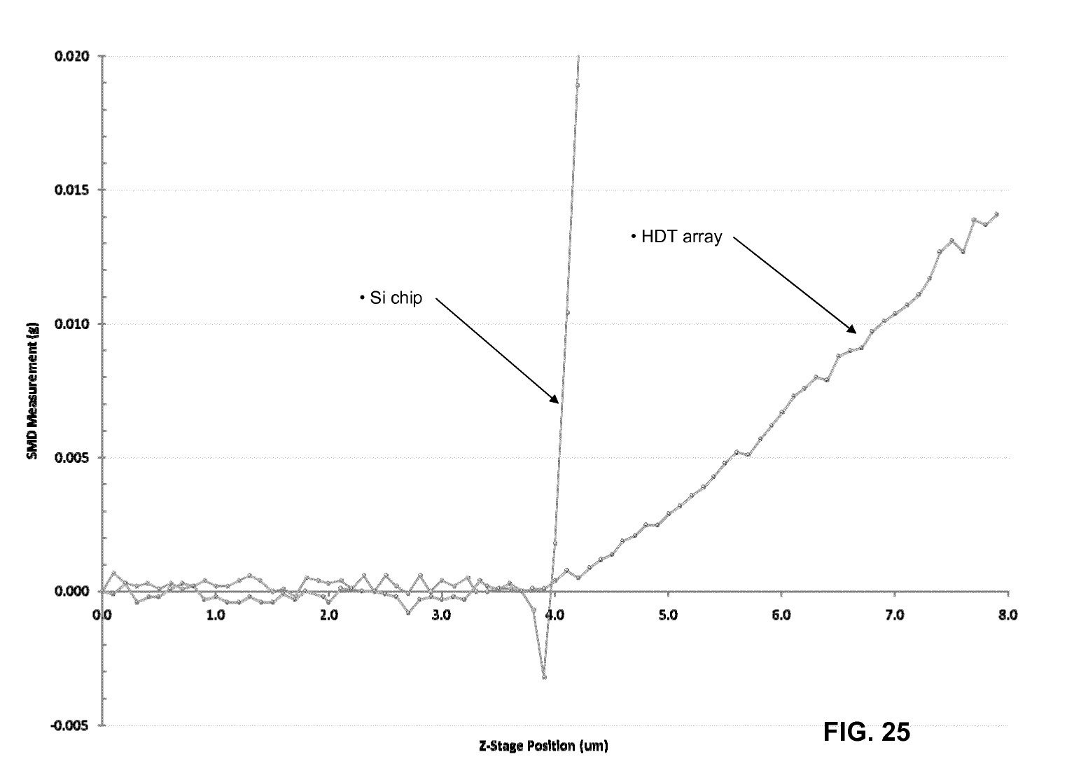

FIG. 25 depicts a sample graph of the force measured by the load cell vs. the position of the stage plate when the contact occurs. FIG. 25 shows curves for both a silicon chip and the HDT array of this working example. Note that the slope of the curve is higher for the harder silicon chip than it is for the HDT array. However, the load cell used was adequate to determine when contact occurred for the HDT array.

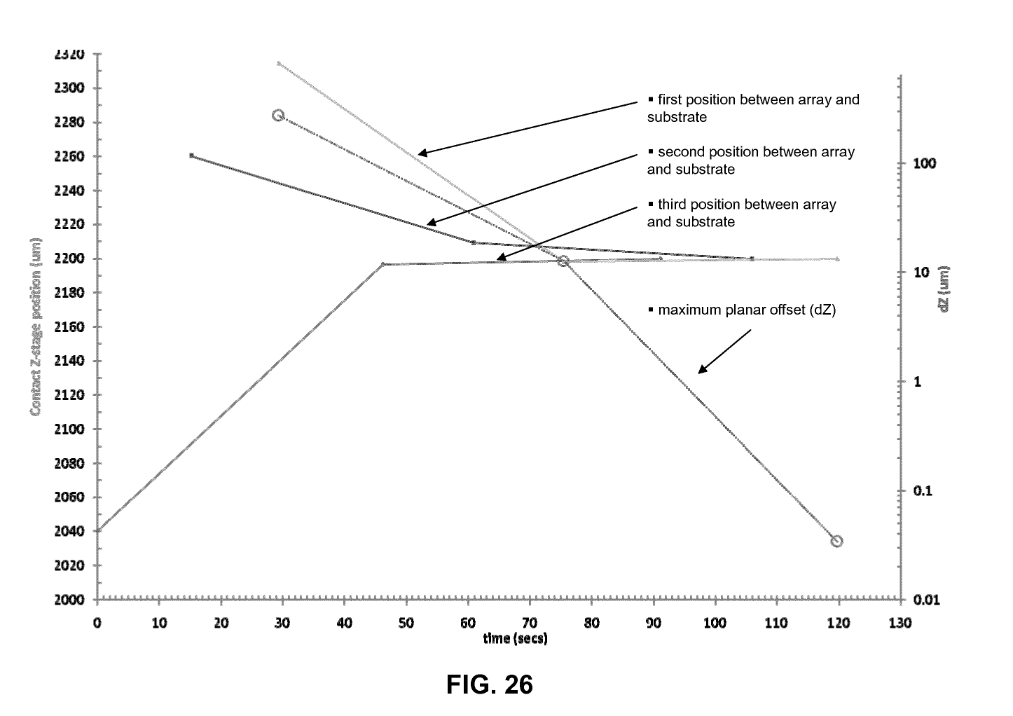

FIG. 26 depicts a graph with curves showing the positions of the stage plate vs. time for each of the three positions between the array and the substrate, along with a curve showing the planar offset of the array with respect to the substrate vs. time. After the first correction, the planar offset fell from over 100 μm to about 10 μm. After the second correction, the planar offset fell to less than 100 nm. The entire process was performed in less than 2 minutes. The results achieved by the present invention, particularly the combination of speed, accuracy, and leveling precision achieved, are unexpected in view of the results achieved by conventional leveling methods.

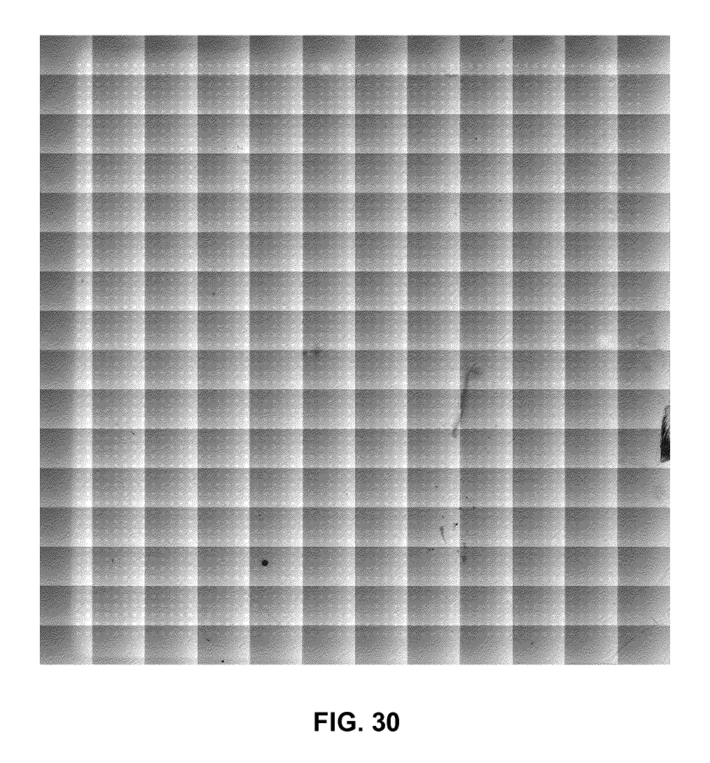

FIG. 30 depicts a 5 mm by 5 mm area that has been printed with an array that is not perfectly parallel to a substrate surface. Note that the quality of the printing is better in the top left region of the printed area than in the bottom right region of the printed area.

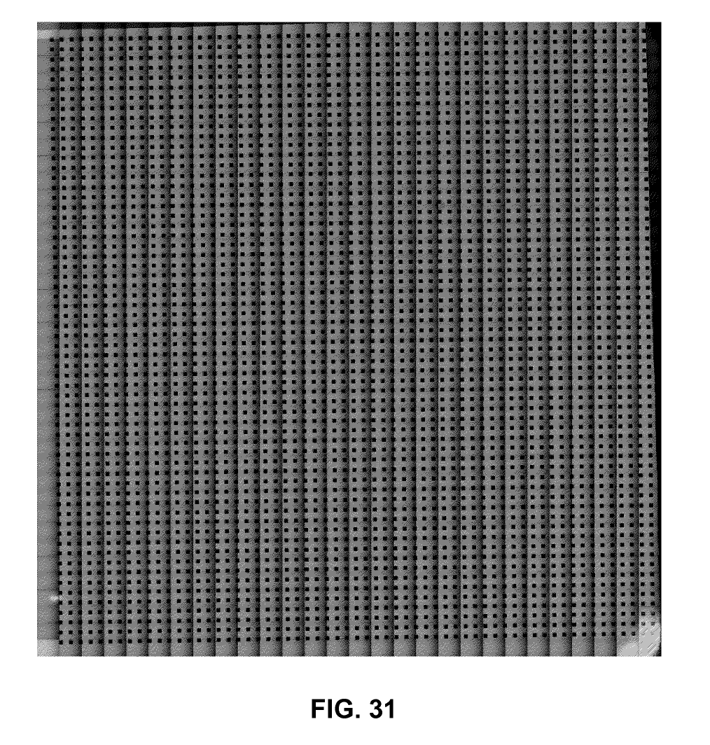

FIG. 31 depicts a 5 mm by 5 mm area that has been printed after the substrate was leveled to the array using the above-described method. The use of the ball-spacer method before printing allowed for uniform high quality printing over the entire printed area.

### Contact Measurement Precision

Contact measurement precision is defined as the ball-spacer system's ability to use a ball contacting the substrate and the array and exceed a given load threshold, thus recognizing contact. The Z-position at which this threshold is crossed may be recorded. When performed many times, a statistical spread of Z-positions may be created. The standard deviation of this statistical spread is the contact measurement precision. Thus, the lower the contact measurement precision, the better the results.

Two experimental requirements dictate the necessary contact measurement precision of the system: (1) intended dot size and (2) acceptable coefficient of variation (“CV”). The CV is the degree to which printed dot sizes vary due to the tips being unlevel. Thus, the CV can be determined using the equation:

$$CV = \frac{σ}{μ}$$

where σ is the standard deviation of the dot size and μ is the average dot size.

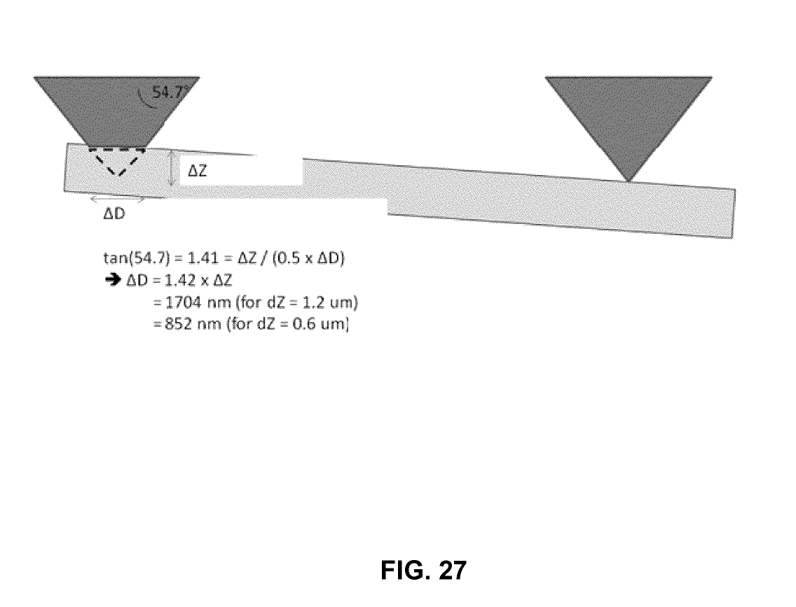

FIG. 27 depicts two tips in contact with a substrate, where there is a planar offset of the tips with respect to the substrate. In FIG. 27, it is assumed that any degree of non-planarity translates into a commensurate compression of the tip such that the footprint of the tip is approximated by the truncated triangle shown. Furthermore, it is assumed that the tips do all of the compressing first, so that virtually all of the Z-stage travel is absorbed by the deformation of the tips.

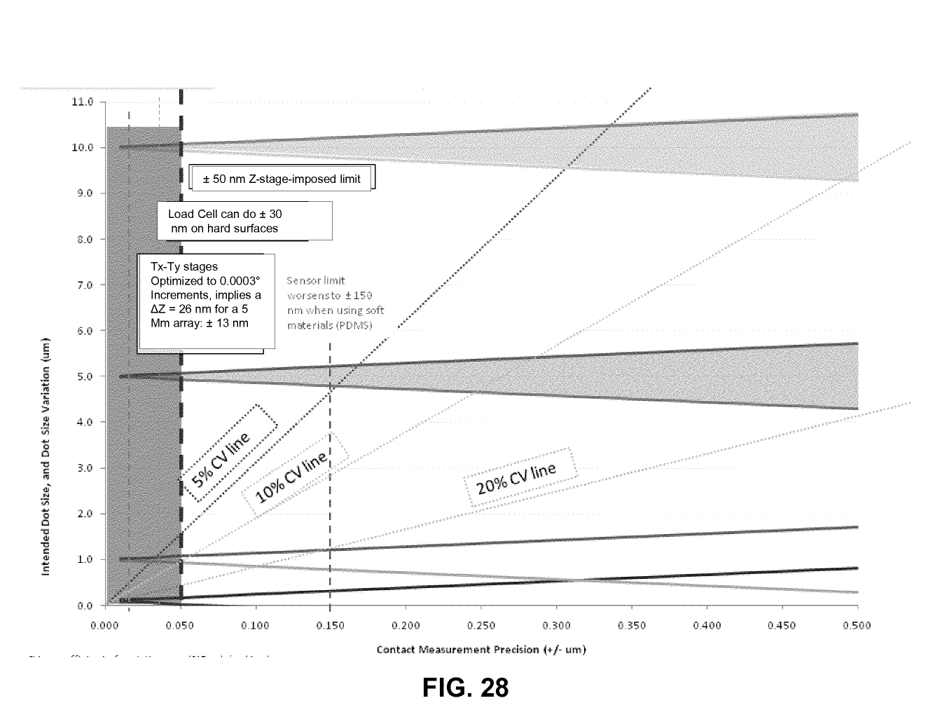

FIG. 28 is a graph showing the contact measurement precision required to obtain an intended dot size. Several restraints may determine the minimum possible contact measurement precision. One such restraint is the minimum angle by which the Z-stage may be adjusted (tip and tilt angles). For example, if the minimum angle by which the Z-stage can be adjusted is 0.0003° and the array is 5 μm wide, the minimum possible contact measurement precision that can be achieved is ±13 nm, as determined by the equation:

CMPₘᵢₙ=5 tan(0.0003).

A second restraint is the sensor detection limit, which is the minimum distance that the Z-stage must travel while in contact with the ball and the array before the it can be certain that contact has been made. The restraint is largely affected by the noise floor and the signal-to-noise ratio of the load cell, as well as the materials of the array and the substrate. If the load cell signal is very noisy, it is difficult to know what is a noise spike an what represents real contact between the array and the substrate. For a given noise level of a load cell, a hard material is easier and faster to detect than a soft one. In FIG. 28, for example, the sensor detection limit is shown to be ±30 nm for hard surfaces and ±150 nm for a soft surface. As shown in FIG. 25, a softer material array, such as an HDT array, requires many more Z-points before it is clear that contact has occurred.

When the actuator is configured to move the Z-stage in a stepwise motion, one restraint is the Z-stage increment, which is the minimum distance by which the Z-stage may be moved in a vertical direction. The minimum measurement precision is one half the minimum Z-stage increment. FIG. 28 shows the Z-stage imposed limit for a Z-stage having a minimum increment of 100 nm. Thus, in this case, the Z-stage imposed limit of the contact measurement prevision is ±50 nm. However, this restraint is largely eliminated by using continuous motion of the Z-stage.

When the actuator is configured to move the Z-stage in a continuous motion, one restraint, not shown in FIG. 28, is the sampling rate or sampling period, which determines how quickly the controller can correlate the movement of the Z-stage with the force measured by the force sensor.

As can be seen in FIG. 28, for a given intended dot size, the dot size variation across the printed area increases linearly as the contact measurement precision gets poorer (i.e. larger). This is shown by the horizontally expanding triangles on the graph. The diagonal CV lines are just a few representation of where intended dot size and CV intersect to dictate a necessary contact measurement precision. For example, to create a 5 μm dot with no worse than 10% CV, a contact measurement precision of at least ±265 nm is required. Thus, it is desirable to operate on the left side of the graph, though this may be limited by the restraints discussed above.

Patterning with Large Pen Numbers and Large Size Pen Arrays Over Large Areas with Improved Results and Efficiency

In one embodiment, the array of tips is characterized by an area of tips on the array which is at least one square millimeter. In one embodiment, the array of tips is characterized by an area of tips on the array which is at least one square centimeter. In one embodiment, the array of tips is characterized by an area of tips on the array which is at least 75 square centimeters.

In one embodiment, a fraction of the tips transfer ink to the substrate, and the fraction is at least 75%. In one embodiment, a fraction of the tips transfer ink to the substrate, and the fraction is at least 80%. In one embodiment, a fraction of the tips transfer ink to the substrate, and the fraction is at least 90%.

In one embodiment, the array of pens comprises at least 10,000 pens. In one embodiment, the array of pens comprises at least 55,000 pens. In one embodiment, the array of pens comprises at least 100,000 pens. In one embodiment, the array comprises at least 1,000,000 pens.

In one embodiment, the array of pens is characterized by an area of pens on the array which is at least one square millimeter. In one embodiment, the array of pens is characterized by an area of pens on the array which is at least one square centimeter. In one embodiment, the array of pens is characterized by an area of pens on the array which is at least 75 square centimeters.

In one embodiment, a fraction of the pens transfer an ink to the substrate, and the fraction is at least 75%. In one embodiment, a fraction of the pens transfer an ink to the substrate, and the fraction is at least 80%. In one embodiment, a fraction of the pens transfer an ink to the substrate, and the fraction is at least 90%. The leveling methods and instruments described herein can increase the fraction of pens which transfer ink to substrate.

1. An apparatus comprising:
an array of microscopic pens;
a substrate having a substrate surface;
a controllable arm comprising a spherical ball on an end thereof, wherein the controllable arm is configured to move the ball to a plurality of positions between the array and the substrate surface;
a force sensor configured to measure a force exerted on the array or the substrate surface at each of the plurality of positions;
one or more actuators configured to drive the array and/or the substrate to vary a relative distance and a relative tilting between the array and the substrate surface; and
a controller configured to (i) determine a planar offset of the array with respect to the substrate based on a distance traveled by the array or the substrate at each of the plurality of positions before the force measured by the force sensor exceeds a given threshold and (ii) initiate a leveling of the array with respect to the substrate using the one or more actuators based on the planar offset.

2. The apparatus of claim 1, wherein the array of pens comprise tips disposed on cantilevers.

3. The apparatus of claim 1, wherein the array of pens comprise an array of AFM tips disposed on microcantilevers.

4. The apparatus of claim 1, wherein the array of pens comprise elastomeric polymer tips.

5. The apparatus of claim 1, wherein the array of pens is a two dimensional array of pens.

6. The apparatus of claim 1, wherein the force sensor is configured to measure a force in the range of 1 pN to 1 N.

7. The apparatus of claim 1, wherein the force sensor comprises a load cell, a capacitive element, an inductive element, a piezoelectric element, a cantilever beam, an optical encoder, a strain gauge, a load transducer, a linear velocity displacement transducer, a laser triangulation sensor, or a confocal sensor.

8. The apparatus of claim 1, further comprising a device configured to measure the distance between the array and the substrate surface.

9. The apparatus of claim 1, further comprising a controller configured to:
iteratively vary the relative distance between the array and the substrate.

10. The apparatus of claim 1, further comprising an enclosure configured to enclose at least the array and to keep an inside temperature at a constant temperature higher than an ambient temperature.

11. The apparatus of claim 1, further comprising:
a device configured to monitor an environmental change including one of a temperature, a relative humidity, or a vibration; and
a device configured to compensate for the environmental change.

12. The apparatus of claim 1, wherein the array of pens is inked with a patterning ink to be transferred to the substrate surface.

13-17. (canceled)

18. The apparatus according to claim 1, wherein the actuator comprises at least one piezoelectric material.

19-20. (canceled)

21. The apparatus according to claim 1, further comprising an array handle by which the array may be attached to the force sensor.

22. The apparatus according to claim 21, further comprising a kinematic mount by which the array handle may be attached to the force sensor.

23. The apparatus according to claim 22, wherein the array handle comprises at least one spherical magnet and the kinematic mount comprises at least one mounting area corresponding to the spherical magnet.

24. The apparatus according to claim 1, wherein the array includes at least one leveling portion comprising a material that is harder than a material of the array.

25. The apparatus according to claim 1, further comprising a mount slide to which the substrate is removably attached.

26. The apparatus according to claim 25, further comprising a stage plate to which the mount slide is removably attached.

27. The apparatus according to claim 26, wherein the one or more actuators is configured to drive the substrate via the stage plate to vary the relative distance and the relative tilting between the array and the substrate surface.

28. The apparatus according to claim 27, wherein the one or more actuators is configured to control a tip and a tilt of the stage plate.

29. The apparatus according to claim 26, wherein the stage plate is made of a non-ferrous material.

30. The apparatus according to claim 26, wherein the stage plate is a vacuum stage plate.

31. (canceled)

32. The apparatus according to claim 1, wherein the controllable arm comprises a flexible portion and a rigid portion.

33. The apparatus according to claim 32, wherein the ball is located at an end of the flexible portion of the controllable arm such that the ball is movable between the array and the substrate surface.

34. The apparatus according to claim 1, wherein the ball is made of sapphire.

35. (canceled)

36. The apparatus according to claim 35, further comprising a mounting frame that holds the controllable arm, wherein the mounting frame is configured to be attached to the chassis.

37. The apparatus according to claim 1, wherein the force sensor has a load limit of 30 g or less.

38. The apparatus according to claim 1, wherein the force sensor has a noise floor of 0.25 mg or less.

39. The apparatus according to claim 1, further comprising a load cell digitizer configured to convert a signal from the force sensor into a signal that is readable by the controller.

40. The apparatus according to claim 1, further comprising:
a stage plate to which the mount slide is removably attached,
wherein the one or more actuators is configured to drive the substrate via the stage plate to vary the relative distance and the relative tilting between the array and the substrate surface, and wherein the one or more actuators is configured to control a tip and a tilt of the stage plate,
wherein the force sensor comprises a load cell,
wherein the controllable arm comprises a flexible portion and a rigid portion, wherein the ball is located at an end of the flexible portion of the controllable arm such that the ball movable between the array and the substrate surface, and
wherein the ball is made of sapphire.

41. The apparatus according to claim 1, wherein the array of microscopic pens comprises a plurality of hard tips and a soft backing.

42. The apparatus according to claim 1, further comprising an intermediary object configured to be disposed between the array and the ball or the ball and the substrate surface, wherein the intermediary object is configured to prevent contamination of the array or the substrate surface, and wherein the intermediary object substantially matches a planarity of the substrate surface.

43. The apparatus according to claim 1, further comprising an intermediary slab configured to be disposed between the array and the ball or the ball and the substrate surface, wherein the intermediary object is configured to prevent contamination of the substrate surface, and wherein the intermediary slab substantially matches a planarity of the substrate surface.

44. A method comprising:
moving a ball to a plurality of positions between an array of microscopic pens and a surface of a substrate;
at each of the plurality of positions, (i) decreasing a relative distance between the array and the substrate surface using one or more actuators until the ball contacts both the array and the substrate surface and a force measured by a force sensor exceeds a given threshold, and (ii) determining a distance traveled by the array or the substrate before the force measured by the force sensor exceeds the threshold; and
determining a planar offset of the array with respect to the substrate surface based on the determined distances.

45. The method of claim 44, wherein the planar offset is determined using a difference in the distances traveled by the array or the substrate at each of the plurality of positions.

46. The method of claim 44, wherein the planar offset is determined by using a distance between each of the plurality of positions.

47. The method of claim 44, further comprising adjusting a relative tilting between the array and the substrate surface using the one or more actuators to level the array to the substrate surface.

48. (canceled)

49. The method of claim 44, wherein:
the plurality of positions comprises a first position and a second position, and
the determination of the planar offset is further based on a distance between the first position and the second position.

50. The method of claim 49, wherein:
the plurality of positions further comprises a third position, and
the determination of the planar offset is further based on a distance between the second position and the third position.

51. The method of claim 44, wherein the ball is moved using a controllable arm.

52. The method of claim 51, wherein the ball is located on an end of the controllable arm.

53. The method of claim 44, further comprising:
monitoring an environmental change including at least one of a temperature, and a vibration; and
compensating for the environmental change.

54. The method of claim 44, further comprising pre-leveling the array and the substrate using a passive device.

55. The method of claim 44, wherein the plurality of positions comprises exactly three positions.

56. A method comprising:
moving a ball to a plurality of positions between an array of microscopic pens and a surface of a substrate;
determining a planar offset of the array with respect to the substrate surface using the ball.

57-59. (canceled)

60. An apparatus comprising:
a mounting frame configured to be attached to a load cell chassis, the mounting frame comprising a controllable arm, and the controllable arm comprising a spherical ball on an end thereof,
wherein the controllable arm is configured to move the ball to a plurality of positions between an array and a substrate surface.

61. The apparatus according to claim 60, further comprising at least one motor configured to move the controllable arm such that the ball is moved to the plurality of positions between an array and a substrate surface.

62. The apparatus according to claim 61, wherein the at least one motor comprises a first motor configured to move the controllable arm along a first axis, and a second motor configured to swing the controllable arm about a second axis.

63. (canceled)

64. A method comprising:
providing an array of microscopic pens and a substrate having a substrate surface, wherein either the array or the substrate comprises a plurality of balls, each ball being located at one of a plurality of positions on the array or the substrate surface;
at each of the plurality of positions, (i) lining up the ball at that position with an opposing portion of the array or substrate surface, (ii) decreasing a relative distance between the array and the substrate surface using one or more actuators until the ball contacts the opposing array or substrate surface and a force measured by a force sensor exceeds a given threshold, and (iii) determining a distance traveled by the array or the substrate before the force measured by the force sensor exceeds the threshold; and
determining a planar offset of the array with respect to the substrate surface based on the determined distances.

65-69. (canceled)
